(19) United States
(12) Patent Application Publication
(10) Pub. No.: US 2025/0373506 A1
(43) Pub. Date: Dec. 4, 2025

(54) ITERATIVE MACHINE LEARNING IN A COMMUNICATION NETWORK

(71) Applicant: TELEFONAKTIEBOLAGET LM ERICSSON (PUBL), Stockholm (SE)

(72) Inventors: JING YUE, STOCKHOLM (SE); ZHANG FU, STOCKHOLM (SE); ULF MATTSSON, GÖTEBORG (SE)

(21) Appl. No.: 18/876,388

(22) PCT Filed: Jun. 30, 2023
(86) PCT No.: PCT/EP2023/068103

§ 371 Date: Dec. 18, 2024

Related U.S. Application Data
(60) Provisional application No. 63/357,594, filed on Jun. 30, 2022.

(51) Int. Cl. H04L 41/16; H04W 24/10

(52) U.S. Cl. CPC H04L 41/16; H04W 24/10

(57) ABSTRACT

Embodiments descried herein relate to methods and apparatuses for iterative machine learning training in a communication network. A method performed by a client data analytics node comprises, for each round of training: training a local machine learning model at the client data analytics node with local training data; and transmitting, to a sever data analytics node, a report that includes local model information resulting from the training in the round, wherein the report comprises an identifier of the round for which the report includes local model information.

### TECHNICAL FIELD

Embodiments described herein relate to methods and apparatuses for iterative machine learning training in a communication network.

### BACKGROUND

A communication network can exploit machine learning to better support the communication services it provides. For example, machine learning can be used to learn and predict patterns in the demand for resources over time, so that the communication network can optimize resource allocation over time.

Distributed machine learning (DML) distributes machine learning training across multiple nodes. In some types of DML, such as federal learning, different client nodes perform training locally using training data local to the respective nodes and a server node aggregates the results of the client nodes' local training. DML advantageously accelerates the speed of training so as to reduce training time, relieves congestion in the communication network by limiting the amount of data sent to a central node, and/or protects sensitive information so as to preserve data privacy.

### SUMMARY

Challenges exist in implementing DML under some circumstances, though. Distribution of training amongst multiple client nodes proves problematic for coordinated training when the training is iterative so as to occur over the course of multiple rounds. In this regard, uncoordinated training amongst distributed client nodes over multiple rounds jeopardizes the accuracy and/or optimality of the resulting machine learning model. Such a jeopardized model in turn threatens to degrade communication network performance, e.g., in terms of sub-optimal resource allocation, etc.

Some embodiments herein effectively provide coordinated machine learning training amongst multiple distributed client nodes that perform training iteratively over the course of multiple rounds. In some embodiments, for example, each client node reports local model information resulting from its local training along with a round identifier identifying the round for which the local model information is reported. Alternatively or additionally, each client node in some embodiments reports local model information resulting from its local training along with a version identifier identifying the version of global model information on which its local training in the round is based. Even if client nodes report their respective local model information asynchronously, then, the server node can exploit the accompanying round identifiers and/or version identifiers to nonetheless combine local model information that is reported for the same round of training and/or that is based on the same version of global model information.

In other embodiments, each client node alternatively or additionally reports local model information resulting from its local training in accordance with a report timing requirement for each round. The requirement may for example require that the report for the round be transmitted within a certain amount of time since the start of the round. The report timing requirement may thereby coordinate the timing of when client nodes report their local model information on a round by round basis, e.g., so as to establish a maximum delay for reporting local model information for each round. Again, then, even if client nodes report their respective local model information asynchronously, the report timing requirement nonetheless establishes a common timeframe according to which the server node can expect reports from the client nodes. Upon expiration of the report timing requirement for each round, the server node can combine any local model information reported so far, e.g., on the assumption that the report t12iming requirement ensures the local model information combined is reported for the same round of training and/or is based on the same version of global model information.

Whether exploiting round identifiers, version identifiers, and/or a report timing requirement, some embodiments herein advantageously ensure the accuracy and/or optimality of distributed machine learning training. When used in the context of a communication network, some embodiments in turn improve communication network performance, e.g., in terms of optimal resource allocation, etc.

More particularly, embodiments herein include a method performed by a client data analytics node for iterative machine learning training in a communication network. The method comprises, for round of training, training a local machine learning model at the client data analytics node with local training data. The method also comprises, for round of training, transmitting, to a server data analytics node, a report that includes local model information resulting from the training in the round. In some embodiments, the report comprises an identifier of the round for which the report includes local model information. In some embodiments, the report identifies a version of global model information on which the local machine learning model trained in the round is based. In some embodiments, the version of the global model information either comprises initial global model information for an initial round of training or represents a combination of local model information reported to the server data analytics node for a previous round by multiple respective client data analytics nodes. In some embodiments, the report is transmitted according to a report timing requirement for the round.

In some embodiments the method comprises receiving, from the server data analytics node prior to the step of training, a message that includes the identifier of the round.

In some embodiments, for each round of training, the method further comprises obtaining the local machine learning model to be trained in the round, based on a version of global model information included in a message received from the server data analytics node in a previous round. In some embodiments, the message received from the server data analytics node in the previous round includes a round identifier that identifies the previous round. In some embodiments, training the local machine learning model comprises training the obtained local machine learning model. In some embodiments, for each round of training, the method further comprises obtaining a round identifier that identifies the round by incrementing the round identifier that identifies the previous round. In some embodiments, the report transmitted for the round includes the obtained round identifier that identifies the round. In some embodiments, for each round of training, the method further comprises receiving, from the server data analytics node, a message. The message includes the round identifier identifying the round. The message also includes a version of global model information that represents a combination of local model information reported to the server data analytics node for the round by multiple respective client data analytics nodes. In some embodiments, the report transmitted for the round further includes a version identifier that identifies the version of global model information on which the local machine learning model trained in the round is based.

In some embodiments, the method further comprises transmitting, to the server data analytics node, a message that requests or updates a subscription to changes in global model information at the server data analytics node. In some embodiments, the message received from the server data analytics node is a message notifying the client data analytics node of a change in global model information at the server data analytics node in accordance with the subscription.

In some embodiments, the report timing requirement for the round requires that the report for the round be transmitted within a certain amount of time since a start of the round. In some embodiments, the method further comprises receiving, from the server data analytics node, a message indicating the report timing requirement for each round.

In some embodiments, the report transmitted for each round is included in a message that requests or updates a subscription to changes in global model information at the server data analytics node.

In some embodiments, the method further comprises receiving, from the server data analytics node, a message that requests or updates a subscription to changes in local model information at the client data analytics node. In some embodiments, the report transmitted for each round is included in a message that notifies the server data analytics node of changes in local model information at the client data analytics node.

In some embodiments, the report transmitted for each round is transmitted during a machine learning execution phase as part of a machine learning aggregation service or a machine learning model provisioning service.

In some embodiments, the method further comprises receiving, from the server data analytics node, a message indicating an endpoint to which to transmit the report for each round of training.

In some embodiments, the method further comprises receiving, from the server data analytics node, a message indicating an identifier of a machine learning process, wherein the report transmitted in each round includes the identifier of the machine learning process.

In some embodiments, the method further comprises receiving, from the server data analytics node, during one or more of the multiple rounds of training, a message that includes an updated machine learning configuration governing training of the local machine learning model.

In some embodiments, local model information includes the local machine learning model or includes one or more parameters of the local machine learning model. In other embodiments, alternatively or additionally, global model information includes a global machine learning model at the server data analytics node or includes one or more parameters of the global machine learning model.

In some embodiments, the local data analytics node implements a local Network Data Analytics Function, NWDAF, and wherein the server data analytics node implements a server NWDAF.

According to some embodiments there is provided a client data analytics node comprising processing circuitry configured to perform the method described above.

According to some embodiments there is provided a client data analytics node comprising processing circuitry and memory, the memory containing instructions executable by the processing circuitry whereby the client data analytics node is configured to perform the method as described above.

According to some embodiments there is provided a computer program comprising instructions which, when executed by at least one processor of a client data analytics node, causes the client data analytics node to carry out the method as described above.

Other embodiments herein include a method performed by a server data analytics node for iterative machine learning training in a communication network. The method comprises, for each round of training, receiving, from each of multiple client data analytics nodes, a report that includes local model information resulting from training of a local machine learning model at the client data analytics node in the round. In some embodiments, the report comprises an identifier of the round for which the report includes local model information. In some embodiments, the report identifies a version of global model information on which the local machine learning model trained in the round is based. In some embodiments, the version of the global model information either comprises initial global model information for an initial round of training or represents a combination of local model information reported to the server data analytics node for a previous round by multiple respective client data analytics nodes. In yet other embodiments, the report alternatively or additionally is transmitted according to a report timing requirement for the round. The method also comprises, for each round of training updating global model information for the round based on the local model information included in the received reports.

In some embodiments, for each of the multiple rounds of training except an initial round, the method further comprises, before receiving the reports, transmitting, to each of the multiple client data analytics nodes, a message that includes a round identifier identifying the round and that includes a version of global model information obtained for a previous round.

In some embodiments, the method further comprises receiving, from each of the multiple client data analytics nodes, a message that requests or updates a subscription to changes in global model information at the server data analytics node. In some embodiments, the message transmitted by the server data analytics node is a message notifying each client data analytics node of a change in global model information at the server data analytics node in accordance with the subscription.

In some embodiments, the report timing requirement for the round requires that the report for the round be received within a certain amount of time since a start of the round. In some embodiments, the method further comprises transmitting, to each of the client data analytics nodes, a message indicating the report timing requirement for each round.

In some embodiments, each report received for each round is included in a message that requests or updates a subscription to changes in global model information at the server data analytics node.

In some embodiments, the method further comprises transmitting, to each of the client data analytics nodes, a message that requests or updates a subscription to changes in local model information at the client data analytics node, wherein each report received for each round is included in a message that notifies the server data analytics node of changes in local model information at the client data analytics node.

In some embodiments, each report received for each round is received during a machine learning execution phase as part of a machine learning aggregation service or a machine learning model provisioning service.

In some embodiments, the method further comprises transmitting, to each of the client data analytics nodes, a message indicating an endpoint to which to transmit the report for each round of training.

In some embodiments, the method further comprises transmitting, to each of the client data analytics nodes, a message indicating an identifier of a machine learning process. In some embodiments, each report received in each round includes the identifier of the machine learning process.

In some embodiments, the method further comprises transmitting, to each of the client data analytics nodes, during one or more of the multiple rounds of training, a message that includes an updated machine learning configuration governing training of the local machine learning model at each client data analytics node.

In some embodiments, local model information includes the local machine learning model at each respective client data analytics node or includes one or more parameters of the local machine learning model at each respective client data analytics node. In other embodiments, alternatively or additionally, global model information includes a global machine learning model at the server data analytics node or includes one or more parameters of the global machine learning model.

In some embodiments, each local data analytics node implements a local Network Data Analytics Function, NWDAF, and wherein the server data analytics node implements a server NWDAF.

According to some embodiments there is provided a server data analytics node comprising processing circuitry configured to perform the method as described above.

According to some embodiments there is provided a server data analytics node comprising processing circuitry and memory, the memory containing instructions executable by the processing circuitry whereby the server data analytics node is configured to perform the method as described above.

According to some embodiments there is provided a computer program comprising instructions which, when executed by at least one processor of a server data analytics node, causes the server data analytics node to carry out the method as described above.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a system for performing machine learning training according to some embodiments;

FIG. 2 illustrates a system for performing machine learning training according to some embodiments;

FIG. 3 depicts a method in accordance with particular embodiments;

FIG. 4 depicts a method in accordance with particular embodiments;

FIG. 5 is a signaling diagram illustrating an example implementation of the methods of FIGS. 3 and 4;

FIG. 6 is a signaling diagram illustrating an example implementation of the methods of FIGS. 3 and 4;

FIG. 7 illustrates an example of a Parameter Server (PS) framework is an underlying architecture of centrally assisted DML;

FIG. 8 illustrates a Federated Averaging framework;

FIGS. 9A and 9B illustrates the context of a general procedure for FL among multiple NWDAF instances;

FIG. 10 illustrates a system for ML with multiple iteration rounds among multiple NWDAF instances according to some embodiments;

FIG. 11 shows the use of service operations of an Nnwdaf_MLAggregation service according to some embodiments;

FIG. 12 illustrates a procedure for model sharing/parameter exchanging in ML execution phase according to some embodiments;

FIG. 13 illustrates the corresponding procedure (to that of FIG. 12) for model sharing/parameter exchanging in the ML execution phase;

FIG. 14 illustrates a client data analytics node as implemented in accordance with one or more embodiments;

FIG. 15 illustrates a server data analytics node as implemented in accordance with one or more embodiments;

FIG. 16 shows an example of a communication system in accordance with some embodiments;

FIG. 17 shows a UE in accordance with some embodiments;

FIG. 18 shows a network node in accordance with some embodiments;

FIG. 19 is a block diagram of a host, which may be an embodiment of the host of FIG. 6, in accordance with various aspects described herein;

FIG. 20 s a block diagram illustrating a virtualization environment in which functions implemented by some embodiments may be virtualized.

### DETAILED DESCRIPTION

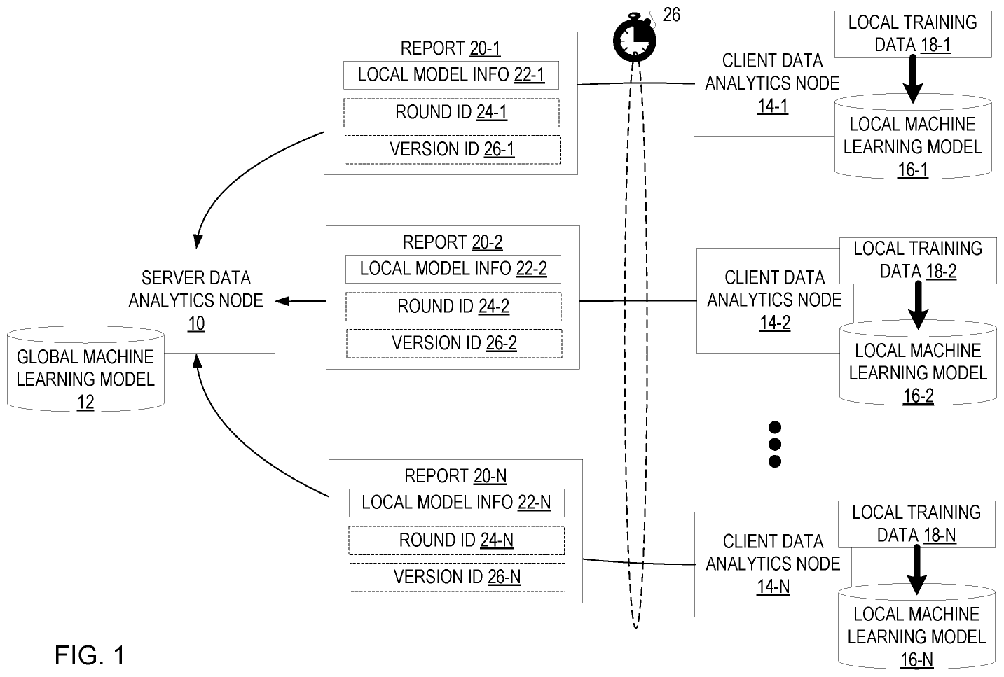

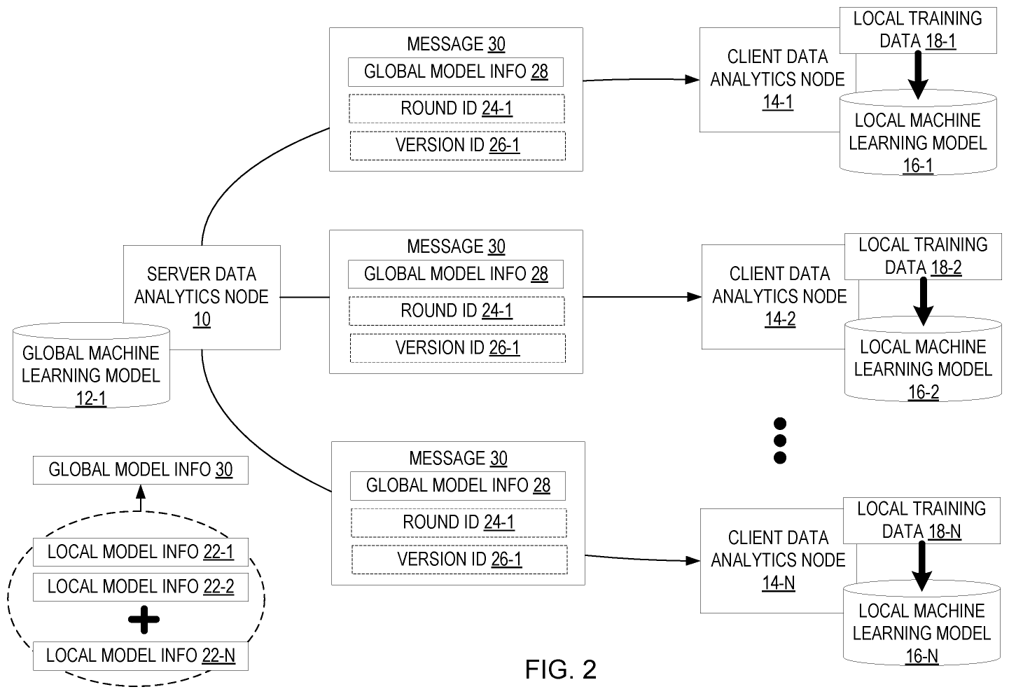

FIGS. 1 and 2 illustrates a system for performing machine learning training, e.g., in a communication network according to some embodiments. Machine learning training according to one or more such embodiments is iterative and distributed. In this regard, the machine learning training is iterative in the sense that it occurs over the course of multiple rounds of training. The machine learning training is distributed in the sense that it is distributed amongst multiple data analytics nodes.

In particular, FIGS. 1 and 2 show a server data analytics node 10 and multiple client data analytics nodes 14-1 . . . 14-N. In some embodiments, each of the server data analytics node 10 and the client data analytics nodes 14-1 . . . 14-N are instances of a Network Data Analytics Function (NWDAF), e.g., as specified by 3GPP for a communication network. Regardless, the server data analytics node 10 controls and/or configures the machine learning training by the client data analytics nodes 14-1 . . . 14-N or otherwise functions as a server for the machine learning training in relation to the client data analytics nodes 14-1 . . . 14-N. The client data analytic nodes 14-1 . . . 14-N by contrast perform machine learning training in a distributed fashion, e.g., without interaction amongst the client data analytic nodes. In some embodiments, the server data analytics node 10 is any data analytics node that functions as a server for the machine learning training, and each client data analytics node 14-1 . . . 14-N is any data analytics node that functions as a client for the machine learning training.

In this context, machine learning training may occur over the course of one or more rounds of training in an iterative fashion. Successive rounds of training may further refine and/or otherwise improve machine learning, e.g., up until a convergence criterion that suggests further rounds of training would not meaningfully improve the machine learning. In some embodiments, the rounds of training are controlled by the server data analytics node 10, e.g., the starting and ending of any given round is controlled by the server data analytics node 10. In this case, then, the rounds of training are rounds from the perspective of the server data analytics node 10.

The server data analytics node 10 maintains a global machine learning model 12, whereas the client data analytics nodes 14-1 . . . 14-N may maintain respective local machine learning models 16-1 . . . 16-N. The local machine learning models 16-1 . . . 16-N are each based on some version of the global machine learning model 12. The server data analytics node 10 may for instance initially configure each of the client data analytics nodes 14-1 . . . 14-N with an initial version of global model information representing the global machine learning model 12, so that the local machine learning models 16-1 . . . 16-N are initially based on that initial version of the global model information. Then, the client data analytics nodes 14-1 . . . 14-N train the local machine learning models 16-1 . . . 16-N over the course of multiple rounds of training, reporting local model information resulting from the training in each round to the server data analytics node 10. The server data analytics node 10 in turn obtains subsequent versions of global model information in each round, by combining local model information reported from the client data analytics nodes 14-1 . . . 14-N in each round, and provides those subsequent versions to the client data analytics nodes 14-1 . . . 14-N for use in training the local machine learning models 16-1 . . . 16-N in subsequent rounds.

FIG. 1 shows additional details of local model information reporting that occurs in each round according to some embodiments. As shown, during a round of training, client data analytics node 14-1 trains its local machine learning model 16-1 based on local training data 18-1. Local model information 22-1 results from this training of the local machine learning model 16-1 in the round. The local model information 22-1 may for example include the trained local machine learning model 16-1 or include one or more parameters of that trained local machine learning model 16-1. Alternatively or additionally, the local model information 22-1 may include feature data from and/or metadata about the trained local machine learning model 16-1. Regardless of what information is contained within the local model information, the client data analytics node 14-1 transmits, to the server data analytics node 10, a report 20-1 that includes the local model information 22-1.

In some embodiments, the client data analytics node 14-1 receives, from the server data analytics node 10, a message that requests or updates a subscription to changes in local model information at the client data analytics node 14-1. In one such embodiment, the report 20-1 is included in a message that notifies the server data analytics node 10 of changes in local model information at the client data analytics node 14-1.

In any event, the report 20-1 advantageously identifies the round for which the report 20-1 includes local model information 22-1. The report 20-1 may for example include a round identifier 24-1 that identifies the round.

Alternatively or additionally, the report 20-1 identifies the version of global model information on which the local machine learning model 16-1 trained in the round is based. Such version of the global model information may either comprise initial global model information for an initial round of training or represent a combination of local model information reported to the server data analytics node 10 for a previous round by multiple respective client data analytics nodes 14-1 . . . 14-N. In one embodiment, for example, the report 20-1 includes a version identifier 26-1 that identifies the version of the global model information.

Alternatively or additionally, the report 20-1 is transmitted according to a report timing requirement 26 for the round. The report timing requirement for the round may for example require that the report 20-1 for the round be transmitted within a certain amount of time since a start of the round.

Similarly, client data analytics node 14-2 trains its local machine learning model 16-2 based on local training data 18-2, and transmits a report 20-2 that includes the local model information 22-2. This report 20-2 identifies the round for which the report 20-2 includes local model information 22-2 (e.g., via round identifier 24-2), identifies the version of global model information on which the local machine learning model 16-2 trained in the round is based (e.g., via version identifier 26-2), and/or is transmitted according to the same report timing requirement 26 for the round.

Similarly, client data analytics node 14-N trains its local machine learning model 16-N based on local training data 18-N, and transmits a report 20-N that includes the local model information 22-N. This report 20-N identifies the round for which the report 20-N includes local model information 22-N (e.g., via round identifier 24-N), identifies the version of global model information on which the local machine learning model 16-N trained in the round is based (e.g., via version identifier 26-N), and/or is transmitted according to the same report timing requirement 26 for the round.

Some embodiments herein exploit the identification of the round in the reports 20-1 . . . 2-N, identification of the version of global model information in the reports 20-1 . . . 20-N, and/or the report timing requirement 26 to effectively provide coordinated machine learning training amongst the multiple distributed client data analytics nodes 14-1 . . . 14-N that perform training iteratively over the course of multiple rounds. For example, even if the client data analytics nodes 14-1 . . . 14-N transmit their respective reports 20-1 . . . 20-N asynchronously, the server data analytics node 10 can exploit the accompanying round identifiers 24-1 . . . 24-N and/or version identifiers 26-1 . . . 26-N to nonetheless combine local model information 22-1 . . . 22-N that is reported for the same round of training and/or that is based on the same version of global model information.

Alternatively or additionally, the report timing requirement 26 may coordinate the timing of when the client data analytics nodes 14-1 . . . 14-N report their local model information 20-1 . . . 20-N on a round by round basis, e.g., so as to establish a maximum delay for reporting local model information for each round. In this case, then, even if the client data analytics nodes 14-1 . . . 14-N transmit their respective reports 20-1 . . . 20-N asynchronously, the report timing requirement 26 may nonetheless establishes a common timeframe according to which the server data analytics node 10 can expect reports from the client data analytics nodes 14-1 . . . 14-N. Upon expiration of the report timing requirement 26 for each round, the server data analytics node 10 can combine any local model information reported so far, e.g., on the assumption that the report timing requirement 26 ensures the local model information combined is reported for the same round of training and/or is based on the same version of global model information.

Whether exploiting round identifiers 24-1 . . . 24-N, version identifiers 26-1 . . . 26-N, and/or a report timing requirement 26, embodiments herein advantageously ensure the accuracy and/or optimality of distributed machine learning training. When used in the context of a communication network, some embodiments in turn improve communication network performance, e.g., in terms of optimal resource allocation, etc.

Note that round identification and/or global model information version identification may be controlled, dictated, or otherwise governed by the server data analytics node 10. FIG. 2 illustrates some embodiments in this regard.

As shown in FIG. 2, for each round of training, the server data analytics node 10 transmits a message 30 to each of the client data analytics nodes 14-1 . . . 14-N. The message 30 includes a version of global model information 28 based on which training of the local machine learning models 16-1 . . . 16-N is to be based in the round. In some embodiments, the message 30 further identifies the round, e.g., via a round identifier 24-1. Alternatively or additionally, the message 30 in some embodiments identifiers the version of the global model information 28, e.g., via version ID 26-1. Alternatively or additionally, the message 30 indicates the report timing requirement 26.

In some embodiments, the server data analytics node 10 receives, from each of the multiple client data analytics nodes 14-1 . . . 14-N, a message that requests or updates a subscription to changes in global model information at the server data analytics node 10. In one such embodiment, the message 30 in FIG. 2 is a message notifying each client data analytics node 14-1 . . . 14-N of a change in global model information at the server data analytics node 10 in accordance with the subscription.

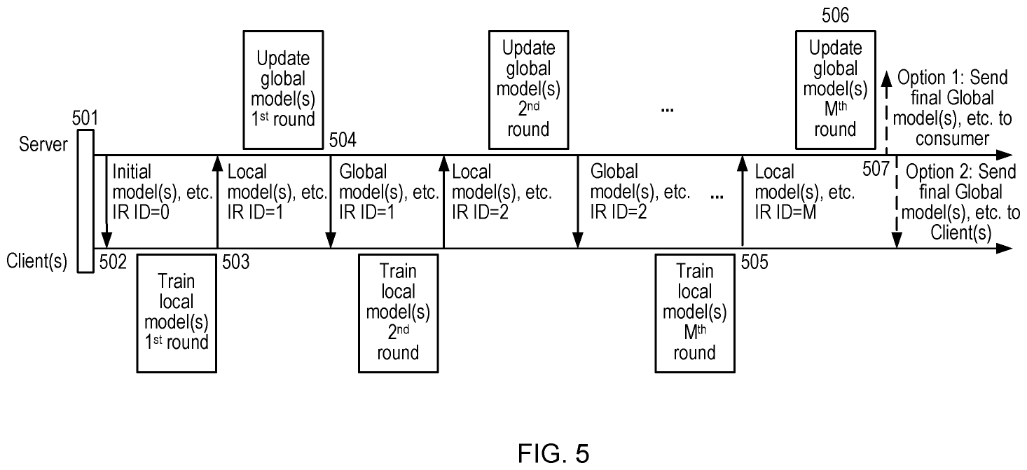

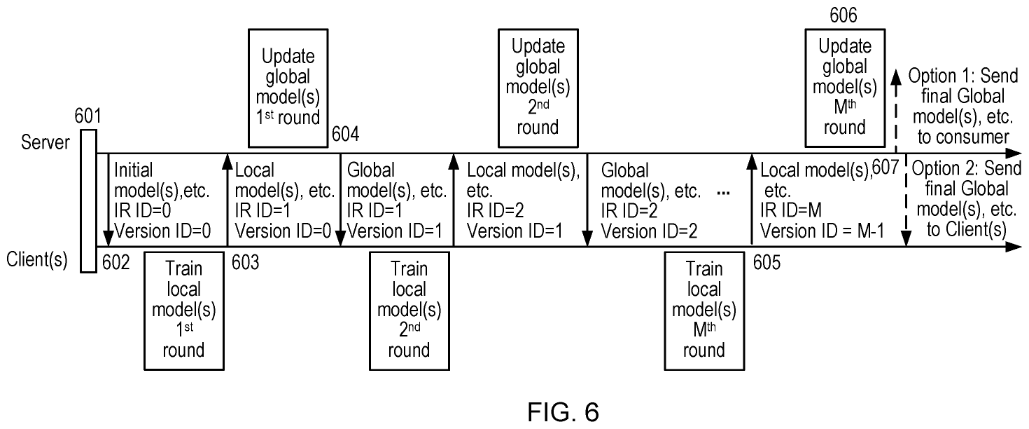

The start and end of each round may be different in different embodiments. FIG. 5 and FIG. 6 show different embodiments in this regard.

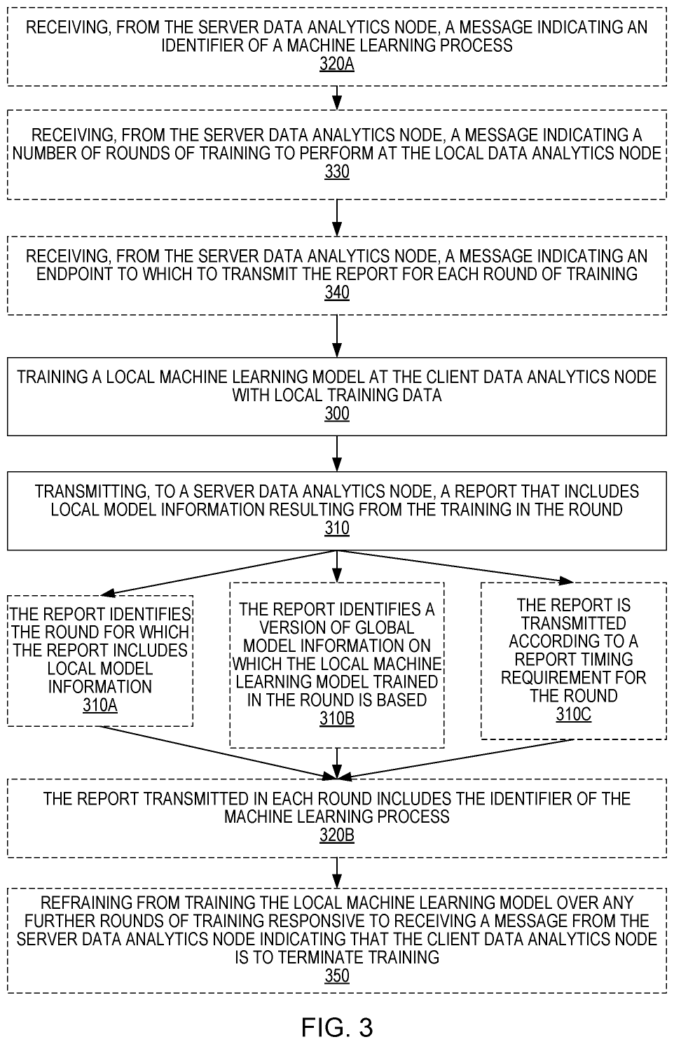

FIG. 3 depicts a method in accordance with particular embodiments. The method is performed by a client data analytics node configured for iterative machine learning training, e.g., in a communication network. For example, the method of FIG. 3 may be performed by any of the client data analytics nodes 14-1 to 14-N illustrated in FIGS. 1 and 2. For each round of training (for example from one or more rounds of training), the method includes training a local machine learning model at the client data analytics node with local training data (Block 300). The method also includes transmitting, to a server data analytics node (e.g. the server data analytics node 10 illustrated in FIG. 1), a report that includes local model information resulting from the training in the round (Block 310).

In some embodiments, the report identifies the round for which the report includes local model information (Block 310A). For example, the report may comprise an identifier of the round for which the report includes local model information. In other embodiments, the report alternatively or additionally identifies a version of global model information on which the local machine learning model trained in the round is based (Block 310B). In yet other embodiments, the report alternatively or additionally is transmitted according to a report timing requirement for the round (Block 310C).

In some embodiments, the method also includes receiving, from the server data analytics node, a message indicating an identifier of a machine learning process (Block 320A). In this case, the report transmitted in each round may include the identifier of the machine learning process (Block 320B).

In some embodiments, the method alternatively or additionally includes receiving, from the server data analytics node, a message indicating a number of rounds of training to perform at the local data analytics node (Block 330). In this case, the steps of training (Block 300) and transmitting the report (Block 310) may be repeated iteratively for the indicated number of rounds.

Alternatively or additionally, the method may include refraining from training the local machine learning model over any further rounds of training responsive to receiving a message from the server data analytics node indicating that the client data analytics node is to terminate training (Block 350). That is, the training may continue indefinitely, or up to the number of rounds indicated by any received message, until receiving such a termination message from the server data analytics node.

In other embodiments, the method alternatively or additionally includes receiving, from the server data analytics node, a message indicating an endpoint to which to transmit the report for each round of training (Block 340). In this case, the report may be transmitted in each round to the indicated endpoint.

In some embodiments, for each round of training, the method further comprises obtaining the local machine learning model to be trained in the round, based on a version of global model information included in a message received from the server data analytics node in a previous round. In some embodiments, the message received from the server data analytics node in the previous round includes a round identifier that identifies the previous round. In some embodiments, training the local machine learning model comprises training the obtained local machine learning model. In some embodiments, for each round of training, the method further comprises obtaining a round identifier that identifies the round by incrementing the round identifier that identifies the previous round. In some embodiments, the report transmitted for the round includes the obtained round identifier that identifies the round. In some embodiments, for each round of training, the method further comprises receiving, from the server data analytics node, a message. The message includes the round identifier identifying the round. The message also includes a version of global model information that represents a combination of local model information reported to the server data analytics node for the round by multiple respective client data analytics nodes. In some embodiments, the report transmitted for the round further includes a version identifier that identifies the version of global model information on which the local machine learning model trained in the round is based.

In some embodiments, for each round of training, the method further comprises, before training the local machine learning model in the round, receiving, from the server data analytics node, a message that includes a round identifier identifying the round and that includes a version of global model information. In some embodiments, the version of the global model information represents a combination of local model information reported to the server data analytics node for a previous round by multiple respective client data analytics nodes. In other embodiments, for each round of training, the method further comprises, obtaining, based on the version of global model information included in the message, the local machine learning model to be trained in the round. In some embodiments, training the local machine learning model comprises training the obtained local machine learning model. In some embodiments, the report transmitted for the round includes the round identifier included in the received message. In some embodiments, the received message further includes a version identifier identifying the version of global model information. In some embodiments, the report transmitted for the round further includes the version identifier included in the received message.

In some embodiments, the method further comprises transmitting, to the server data analytics node, a message that requests or updates a subscription to changes in global model information at the server data analytics node. In some embodiments, the message received from the server data analytics node is a message notifying the client data analytics node of a change in global model information at the server data analytics node in accordance with the subscription.

In some embodiments, the report transmitted for each round is transmitted according to a report timing requirement for the round. In some embodiments, the report timing requirement for the round requires that the report for the round be transmitted within a certain amount of time since a start of the round. In some embodiments, the method further comprises receiving, from the server data analytics node, a message indicating the report timing requirement for each round.

In some embodiments, the report transmitted for each round is included in a message that requests or updates a subscription to changes in global model information at the server data analytics node.

In some embodiments, the method further comprises receiving, from the server data analytics node, a message that requests or updates a subscription to changes in local model information at the client data analytics node. In some embodiments, the report transmitted for each round is included in a message that notifies the server data analytics node of changes in local model information at the client data analytics node.

In some embodiments, the report transmitted for each round is transmitted during a machine learning execution phase as part of a machine learning aggregation service or a machine learning model provisioning service.

In some embodiments, the method further comprises receiving, from the server data analytics node, during each round of training, a message that includes an updated machine learning configuration governing training of the local machine learning model.

In some embodiments, local model information includes the local machine learning model or includes one or more parameters of the local machine learning model. In other embodiments, alternatively or additionally, global model information includes a global machine learning model at the server data analytics node or includes one or more parameters of the global machine learning model.

In some embodiments, the local data analytics node implements a local Network Data Analytics Function, NWDAF, and wherein the server data analytics node implements a server NWDAF.

In some embodiments, a start and/or end of each round of training is controlled by the server data analytics node.

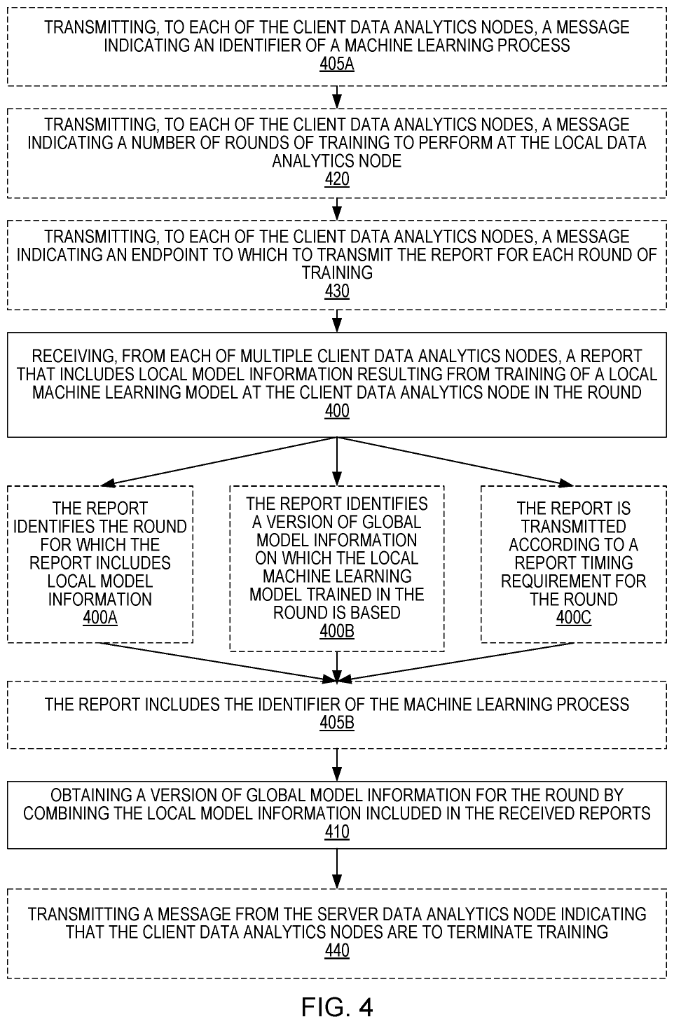

FIG. 4 depicts a method in accordance with other particular embodiments. The method is performed by a server data analytics node configured for iterative machine learning training, e.g., in a communication network. For example, the method of FIG. 4 may be performed by the server data analytics node 10 illustrated in FIG. 1. The method includes, for each round of training, receiving, from each of multiple client data analytics nodes (e.g. client data analytics nodes 14-1 to 14-N illustrated in FIG. 1), a report that includes local model information resulting from training of a local machine learning model at the client data analytics node in the round (Block 400).

In some embodiments, the report identifies the round for which the report includes local model information (Block 400A). For example, the report may comprise an identifier of the round for which the report includes local model information. In other embodiments, the report alternatively or additionally identifies a version of global model information on which the local machine learning model trained in the round is based (Block 400B). In yet other embodiments, the report alternatively or additionally is transmitted according to a report timing requirement for the round (Block 4000).

In some embodiments, the method also includes transmitting, to each of the client data analytics nodes, a message indicating an identifier of a machine learning process (Block 405A). In this case, each report received in each round may also include the identifier of the machine learning process (Block 405B).

Regardless, the method also includes obtaining a version of global model information for the round by combining the local model information included in the received reports (Block 410).

In some embodiments, the method also includes transmitting, to each of the client data analytics nodes, a message indicating a number of rounds of training to perform at the local data analytics node (Block 420). In this case, the steps of receiving (Block 400) and obtaining (Block 410) may be repeated iteratively for the indicated number of rounds.

In some embodiments, the method also includes transmitting a message from the server data analytics node indicating that the client data analytics nodes are to terminate training (Block 440). In this case, then, the training may continue indefinitely, or up to the number of rounds indicated by any transmitted message, until transmitting such a termination message from the server data analytics node.

In some embodiments, the method also includes transmitting, to each of the client data analytics nodes, a message indicating an endpoint to which to transmit the report for each round of training (Block 430). In this case, the report may be received in each round at the indicated endpoint.

In some embodiments, for each round of training, the method further comprises, transmitting, to each of the multiple client data analytics nodes, a message that includes a round identifier identifying the round and that includes the obtained version of global model information for the round. In some embodiments, the message further includes a version identifier that identifies the obtained version of global model information for the round. In some embodiments, each report received further includes a version identifier that identifies a previously obtained version of global model information for a previous round.

In some embodiments, for round of training except an initial round, the method further comprises, before receiving the reports, transmitting, to each of the multiple client data analytics nodes, a message that includes a round identifier identifying the round and that includes a version of global model information obtained for a previous round. In some embodiments, the message further includes a version identifier identifying the version of global model information included in the message. In some embodiments, each report received for the round further includes the version identifier included in the transmitted message.

In some embodiments, the method further comprises receiving, from each of the multiple client data analytics nodes, a message that requests or updates a subscription to changes in global model information at the server data analytics node. In some embodiments, the message transmitted by the server data analytics node is a message notifying each client data analytics node of a change in global model information at the server data analytics node in accordance with the subscription.

In some embodiments, each report received for each round is received according to a report timing requirement for the round. In some embodiments, the report timing requirement for the round requires that the report for the round be received within a certain amount of time since a start of the round. In some embodiments, the method further comprises transmitting, to each of the client data analytics nodes, a message indicating the report timing requirement for each round.

In some embodiments, each report received for each round is included in a message that requests or updates a subscription to changes in global model information at the server data analytics node.

In some embodiments, the method further comprises transmitting, to each of the client data analytics nodes, a message that requests or updates a subscription to changes in local model information at the client data analytics node, wherein each report received for each round is included in a message that notifies the server data analytics node of changes in local model information at the client data analytics node.

In some embodiments, each report received for each round is received during a machine learning execution phase as part of a machine learning aggregation service or a machine learning model provisioning service.

In some embodiments, the method further comprises transmitting, to each of the client data analytics nodes, during each round of training, a message that includes an updated machine learning configuration governing training of the local machine learning model at each client data analytics node.

In some embodiments, local model information includes the local machine learning model at each respective client data analytics node or includes one or more parameters of the local machine learning model at each respective client data analytics node. In other embodiments, alternatively or additionally, global model information includes a global machine learning model at the server data analytics node or includes one or more parameters of the global machine learning model.

In some embodiments, each local data analytics node implements a local Network Data Analytics Function, NWDAF, and wherein the server data analytics node implements a server NWDAF.

In some embodiments, a start and/or end of each of the rounds of training is controlled by the server data analytics node.

FIG. 5 is a signaling diagram illustrating an example implementation of the methods of FIGS. 3 and 4.

In step 501 an initial request or pre-configuration may occur at the server data analytics node 10, or between one or more client data analytics nodes 14-1 and the server data analytics node 10, etc.

In step 502, the server data analytics node 10 distributes an initial ML model(s) to one or more client data analytic node(s). In this first round of training, the iteration round identifier, IR ID, =0.

In step 503, the client data analytics node(s) train local ML model(s) based on the initial ML model(s) and local training data for the 1st round, and then send the local ML model(s) to server, with the IR ID=1. Step 503 comprises an example implementation of steps 300, 310, 400 of FIGS. 3 and 4.

In step 504, the server data analytics node updates global ML model(s) based on the received local ML model(s), and sends the updated global ML model(s) to the client data analytics node(s), with the IR ID=1. Step 504 comprises an example implementation of step 410 of FIG. 4.

The steps 503 and 504 are repeated until the final round, e.g., the M^{th} round.

In step 505, in the M^{th} round, the client data analytics node(s) train local ML model(s) based on the global ML model(s) received in M-1^{th} round and the local training data, and then send the local ML model(s) to the server data analytics node, with the IR ID=M. Step 505 comprises an example implementation of steps 300, 310, 400 of FIGS. 3 and 4.

In step 506, at the server data analytics node, final global ML model(s) are generated based on the received local ML model(s). Step 506 comprises an example implementation of step 410 of FIG. 4.

In step 507, the server data analytics node sends the final global model(s) to a consumer or to the client data analytics node(s) according to the pre-configuration or the request in step 501.

FIG. 6 illustrates an example implementation of the methods of FIGS. 3 and 4.

In step 601 an initial request or pre-configuration may occur at the server data analytics node 10, or between a consumer or one or more client data analytics nodes 14-1 and the server data analytics node 10, etc. in step 602, the server data analytics node 10 distributes an initial ML model(s) to the client data analytics node(s). In this first round of training the iteration round identifier, IR ID, =0, and the version identifier, Version ID, =0.

In step 603, the client data analytics node(s) trains local ML model(s) based on the initial ML model(s) (model with Version ID=0) and local data for the 1st round, and then sends the local ML model(s) to the server data analytics node 10, with the IR ID=1, and Version ID=0 (which means that the local ML model(s) was trained based on the global model with Version ID=0). Step 603 comprises an example implementation of steps 300, 310, 400 of FIGS. 3 and 4.

In step 604, the server data analytics node 10 updates global ML model(s) based on the received local ML model(s), and sends the updated global ML model(s) to the client data analytics node(s), with the IR ID=1, and Version ID=1. Step 604 comprises an example implementation of step 410 of FIG. 4.

The steps 603 and 604 are repeated until the final round, e.g., the M^{th} round.

In step 605, in the M^{th} round, the client data analytics node(s) trains local ML model(s) based on the global ML model(s) received in M-1^{th} round (with the Version ID=M-1) and the local data, and then sends the local ML model(s) to server data analytics node, with the IR ID=M, and Version ID=M-1. Step 605 comprises an example implementation of steps 300, 310, 400 of FIGS. 3 and 4.

In step 606, at the server data analytics node 10, the final global ML model(s) is generated based on the received local MI model(s). Step 606 comprises an example implementation of step 410 of FIG. 4.

In step 607 the server data analytics node sends the final global ML model(s) to the consumer or to the client data analytics node(s) according to a pre-configuration or the request in step 601.

Some embodiments herein are applicable for machine Learning (ML) in a range of application domains across industry sectors (See TR 23.700-80 V0.3.0). The training of some types of ML, e.g., Federated Learning (FL) and Distributed Machine Learning (DML), are proceeded in multiple iteration rounds. Iteration round is a term used in ML and indicates the number of times the algorithm's parameters are updated.

### Distributed Machine Learning

Some embodiments herein are applicable for distributed machine learning (DML). In DML, the training process is carried out using distributed resources, which significantly accelerate the training speed and reduce the training time (See J. Liu, et al., “From distributed machine learning to federated learning: A survey.” arXiv preprint arXiv:2104.14362v4, Mar. 25, 2022). DML can relieve congestion in wireless networks by sending a limited amount of data to central servers for a training task, meanwhile protecting sensitive information and preserving data privacy of the devices in wireless networks.

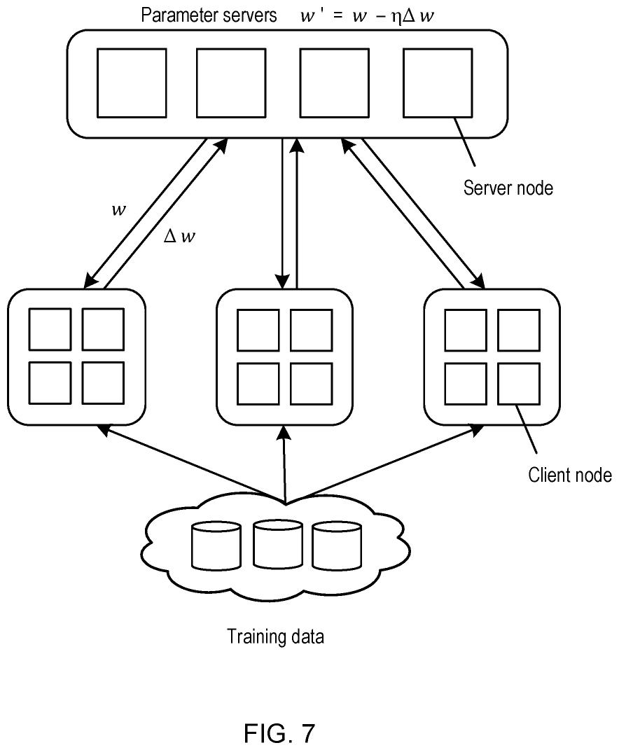

Parameter Server (PS) framework is an underlying architecture of centrally assisted DML. As shown in FIG. 7, there are two kinds of nodes in a PS framework, i.e., server and client (or worker). There may be one or multiple servers. The client nodes are partitioned into groups. The servers maintain the whole or part of all parameters and aggregate the weights from each client group. The client nodes conduct the initial steps of learning algorithm. Unlike a centralized approach, a client uses the synchronized global gradient from the server nodes to carry out back propagation and weight refreshments. In some embodiments, the clients only share the parameters with the servers, and never communicate with each other.

### Federated Learning

Some embodiments herein are particularly applicable for federated learning (FL) as a distributed machine learning approach. As introduced in (See Q. Li, et al., “A survey of federated learning system: Vision, hype and reality for data privacy and protection,” IEEE Transactions on Knowledge and Data Engineering, November 2021), FL enables the collaborative training of machine learning models among different organizations under the privacy restrictions. The main idea of FL is to build machine learning models based on data sets that are distributed across multiple devices while preventing data leakage (See Q. Yang, et al., “Federated machine learning: Concept and applications.” arXiv preprint arXiv: 1902.04885v1, Feb. 13, 2019). In a federated learning system, multiple parties collaboratively train machine learning models without exchanging their raw data. The output of the system is a machine learning model for each party (which can be same or different) (See Q. Li, et al.).

There are three major components in an FL system, i.e., parties (e.g., clients), manager (e.g., server), and communication-computation framework to train the machine learning model (See Q. Li, et al.). The parties are the data owners and the beneficiaries of FL. The manager could be a powerful central server or one of the organizations who dominates the FL process under different settings. Computation happens on the parties and the manager, and communication happens between the parties and the manager. Usually, the aim of the computation is for the model training and the aim of the communication is for exchanging the model parameters.

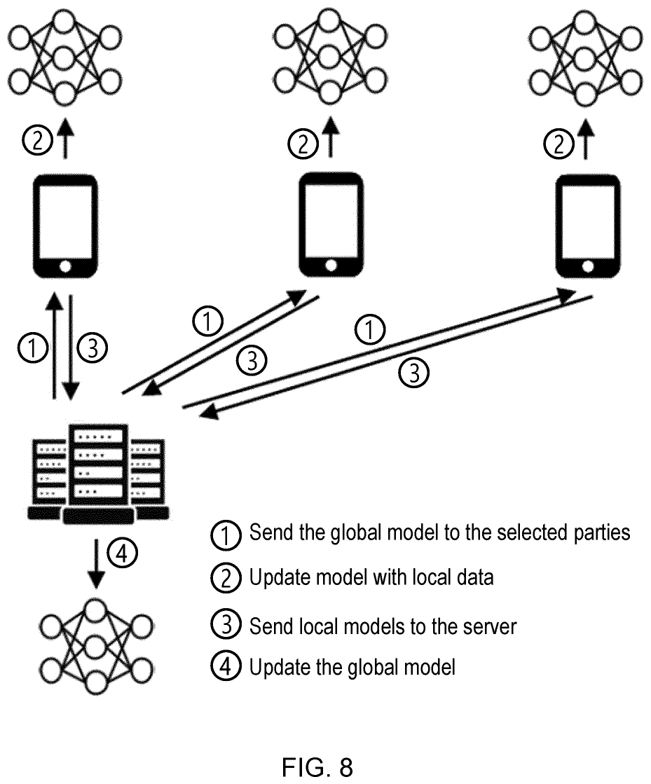

A basic and widely used framework is Federated Averaging (FedAvg) (See H. McMahan, et al., “Communication-efficient learning of deep networks from decentralized data.” arXiv preprint arXiv:1602.05629v3, February 2017) as shown in FIG. 8. In each iteration, the process for FL is as follows. First, the server sends the current global model to the selected parties. Then, the selected parties update the global model with their local data. Next, the updated models are sent back to the server. Last, the server averages all the received local models to get a new global model.

FedAvg repeats the above process until reaching the specified number of iterations. The final output of the server is the final global model (See Q. Li, et al., Q. Yang, et al.).

### Federated Learning Among Multiple NWDAF Instances

Some embodiments herein support Federated Learning in the 5G core (5GC), e.g., to address key issue #8 in clause 5.8 of TR 23.700-81 V0.3.0. Some embodiments herein are thereby applicable to, or comprise a modification of, the general procedure for FL among multiple NWDAF instances given in solution #24 in clause 6.24 of TR 23.700-81 V0.3.0.

In this case, some embodiments address challenges faced by current enablers for network automation architecture by NWDAF. These challenges include user data privacy and security (protected by e.g. GDPR), which has become a worldwide issue, e.g., it is difficult for NWDAF to collect UE level network data. Furthermore, with the introduction of MTLF in Rel-17, various data from wide area is needed to train an ML model for NWDAF containing MTLF. Some embodiments enable NWDAF containing MTLF to collect all the raw data from distributed data source in different areas, because heavy signalling load may exist if it centralized all the data into the NWDAF containing MTLF.

In order to address the challenges, some embodiments facilitate a Federated Learning (also called Federated Machine Learning) technique in NWDAF containing MTLF, to train an ML model, in which there is no need for raw data transferring (e.g., centralized into one NWDAF), but only need for cooperation among multiple NWDAFs (MTLF) distributed in different areas, i.e., sharing of ML model and of the learning results among multiple NWDAFs (MTLF).

During the FL training process, the Server NWDAF can inform the training status to the consumer based on the consumer's request. The consumer could modify subscription to NWDAF for new model requirement. The Server NWDAF will update or terminate the FL training process accordingly.

Embodiments in this case may be applicable for horizontal Federated Learning among Multiple NWDAFs, whose procedures are illustrated in the following clauses.

General procedure for Federated Learning among Multiple NWDAF Instances

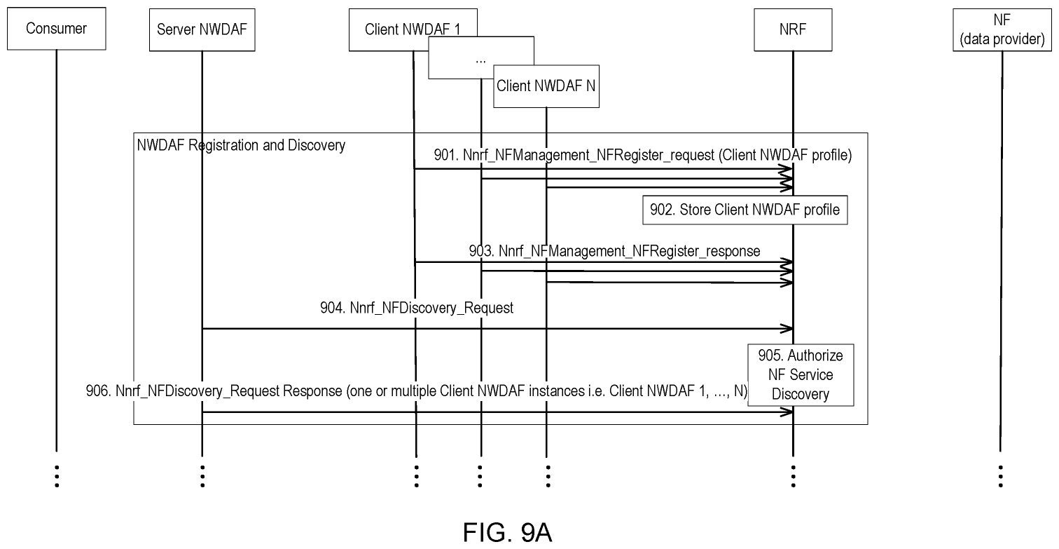

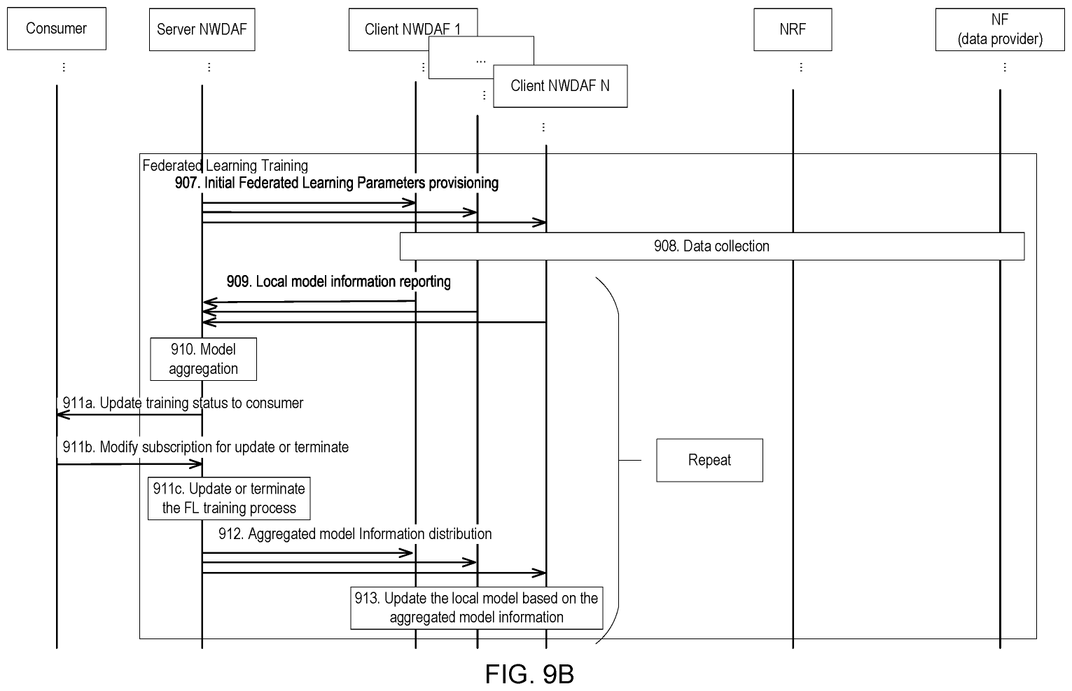

Some embodiments herein are implemented in the context of a general procedure for FL among multiple NWDAF instances, e.g., given in the solution #24 in clause 6.24.2.1 of TR 23.700-81V0.3.0, as shown in FIGS. 9A-9B.

Steps 901-903. Client NWDAF registers its NF profile (Client NWDAF Type (see clause 5.2.7.2.2 of TS 23.502 V17.4.0), Address of Client NWDAF, Support of Federated Learning capability information, Analytics ID(s)) into NRF.

Steps 904-906. Server NWDAF discovers one or multiple Client NWDAF instances which could be used for Federated Learning via the NRF to get IP addresses of Client NWDAF instances by invoking the Nnrf_NFDiscovery_Request (Analytics ID, Support of Federated Learning capability information) service operation.

It is assumed an Analytics Id is preconfigured for a type of Federated Learning. Thus, the NRF can realize the Server NWDAF is requesting to perform federated learning based on the pre-configuration. And the NRF responds to the central NWDAF the IP address of multiple NWDAF instances which support the Analytics Id.

NOTE: The analytic ID(s) supporting Federated Learning can be configured by operator.

Based on the response from NRF, Server NWDAF selects which NWDAF clients will participate.

Step 907. Server NWDAF sends a request to the selected Client NWDAFs that participate in the Federated learning including some parameters (such as initial ML model, data type list, maximum response time window, etc.) to help the local model training for Federated Learning.

NOTE: This step should be aligned with the outcome of KI #5.

Step 908. Each Client NWDAF collects its local data by using the current mechanism in clause 6.2 of TS 23.288 V17.4.0.

Step 909. During Federated Learning training procedure, each Client NWDAF further trains the retrieved ML model from the server NWDAF based on its own data, and reports the results of ML model training to the Server NWDAF, e.g. the gradient.

Step 910. The Server NWDAF aggregates all the local ML model training results retrieved at step 909 such as the gradient to update the global ML model.

Step 911a. Based on the consumer request, the Server NWDAF updates the training status (an accuracy level) to the consumer using Nnwdaf_MLModelProvision_Notify service periodically (one or multiple rounds of training or every 10 min, etc.) or dynamically when some pre-determined status (e.g., some accuracy level) is achieved.

Step 911b. [Optional] Consumer decides whether the current model can fulfil the requirement e.g., accuracy and time. The consumer modifies subscription if the current model can fulfil the requirement.

Step 911c. According to the request from the consumer, the Server NWDAF updates or terminates the current FL training process.

Step 912. [If the FL procedure continues] The Server NWDAF sends the aggregated ML model information (updated ML model) to each Client NWDAF for next ground model training.

Step 913. Each Client NWDAF updates its own ML model based on the aggregated model information (updated ML model) distributed by the Server NWDAF at step 912.

NOTE: The steps 908-913 may be repeated until the training termination condition (e.g., maximum number of iterations, or the result of loss function is lower than a threshold) is reached.

After the training procedure is finished, the globally optimal ML model or ML model parameters could be distributed to the Client NWDAFs for the inference.

Analytics Aggregation from Multiple NWDAFs

Some embodiments herein are applicable in a service-based architecture where one or more services support analytics aggregation in a multiple NWDAF deployment scenario, e.g., described in TS 23.288 V17.4.0, clause 6.1A. In a multiple NWDAF deployment scenario, an NWDAF instance may be specialized to provide Analytics for one or more Analytics IDs. Each of the NWDAF instances may serve a certain Area of Interest or TAI(s). Multiple NWDAFs may collectively serve the particular Analytics ID. An NWDAF may have the capability to support the aggregation of Analytics (per Analytics ID) received from other NWDAFs, possibly with Analytics generated by itself.

### Analytics Aggregation

The analytics aggregation from multiple NWDAFs is used to address cases where an NWDAF service consumer requests Analytics ID(s) that requires multiple NWDAFs to collectively serve the request. Analytic aggregation applies to scenarios where NWDAF service consumer requests or subscribes to analytics information with or without provisioning Area of Interest.

In this context, the aggregator NWDAF or aggregation point is an NWDAF instance with additional capabilities to aggregate output analytics provided by other NWDAFs. This is in addition to regular NWDAF behaviour such as collecting data from other data sources to be able to generate its own output analytics. The aggregator NWDAF or aggregation point is able to divide the area of interest, if received from the consumer, into sub area of interest based on the serving area of each NWDAF to be requested for analytics, and then send analytics requests including the sub area of interest as an Analytics Filter to corresponding NWDAFs. The Aggregator NWDAF may maintain information on the discovered NWDAFs, including their supported Analytics IDs, NWDAF Serving Areas, etc. The aggregator NWDAF or aggregation point has “analytics aggregation capability” registered in its NF Profile within the NRF. The aggregator NWDAF or aggregation point supports the request for and exchange of “Analytics Metadata Information” between NWDAFs when required for the aggregation of output analytics. “Analytics Metadata Information” is additional information associated with the requested Analytics ID(s) as defined in clause 6.1.3 of TS 23.288 V17.4.0. The aggregator NWDAF or aggregation point supports dataset statistical properties, output strategy, and data time window parameters per type of analytics (i.e., Analytics ID) as defined in clause 6.1.3 of TS 23.288 V17.4.0.

The Network Function (NF) Repository Function (NRF) stores the NF Profile of the NWDAF instances, including “analytics aggregation capability” for Aggregator NWDAFs and “analytics metadata provisioning capability” when supported by the NWDAF. The NRF returns the NWDAF(s) matching the attributes provided in the Nnrf_NFDiscovery_Request, as specified in clause 5.2.7.3 of TS 23.502 V17.4.0.

The NWDAF service consumer requests or subscribes to receive analytics for one or more Analytics IDs, as specified in clause 6.1 of TS 23.288 V17.4.0. The NWDAF service consumer uses the discovery mechanism from NRF as defined in clause 6.3.13 of TS 23.501 V17.4.0 to identify NWDAFs with analytics aggregation capability and other capabilities (e.g., providing data/analytics for specific TAI(s)). The NWDAF service consumer can differentiate and select the preferred NWDAF in case multiple NWDAFs are returned in the NWDAF discovery response based on its internal selection criteria (considering the registered NWDAF capabilities and information in NRF or UDM).

Some embodiments herein address certain challenge(s) in this context, e.g., including Key Issue #8 in TR 23.700-81 V17.4.0 for Supporting Federated Learning in 5GC. Since FL is operated in multiple rounds, the local models at Client NWDAFs and global model at Server change with time when the training process is ongoing. However, existing solutions do not enable Server and Client NWDAFs to correlate local and global models during the training process in different iteration rounds. Existing solutions also fail to provide 5GC services that can be used to support ML with multiple iteration rounds among multiple NWDAF instances in 5GC, e.g., for trained model/parameter sharing in the execution phase, etc.

Some embodiments herein in this regard provide new services and service operations to support ML with multiple iteration rounds (e.g., FL, etc.) among multiple NWDAF instances in 5GC.

For example, some embodiments herein include a new Nnwdaf service which supports ML with multiple iteration rounds (e.g., FL, DML, etc.) among multiple NWDAF instances in 5GC. In one embodiment, for instance, a ML aggregation service Nnwdaf_MLAggregation supports trained model sharing/parameter exchanging in the execution phase of ML among multiple NWDAF instances of a ML training process. Such new service, ML aggregation service Nnwdaf_MLAggregation, thereby supports ML with multiple iteration rounds (e.g., FL, DML, etc.) among multiple NWDAF instances in 5GC.

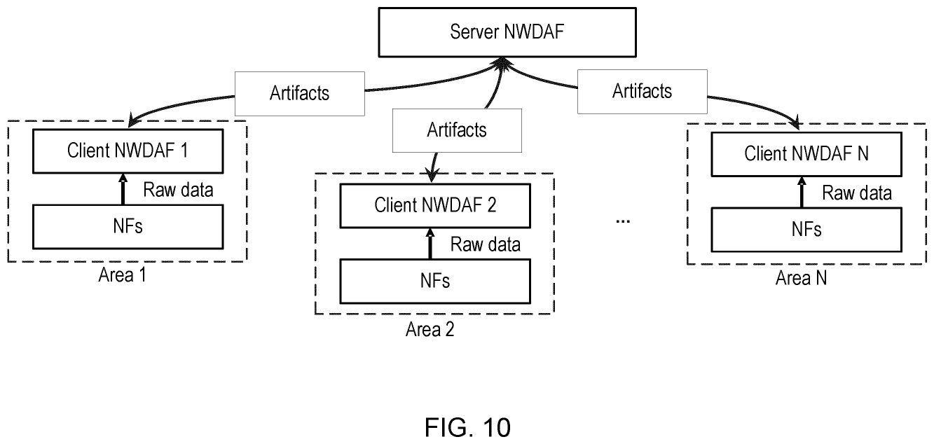

FIG. 10 illustrates a system for ML with multiple iteration rounds among multiple NWDAF instances according to some embodiments. These NWDAF instances may be located at different areas and belong to one vender or scattered among multiple venders. The Artifacts showed in FIG. 10 are artifacts of the ML. The Artifacts may be, for example, feature data, metadata, model parameters (e.g., weights, gradients, etc), and/or models, etc. The Artifacts exemplify local model information and/or global model information herein according to some embodiments.

As shown in FIG. 10, there are in total N+1 NWDAF instances. One of the NWDAFs acts as the Server NWDAF (e.g. the server data analytics node of FIGS. 3 and 4), and the rest N NWDAFs are Client NWDAFs (e.g. the client data analytics nodes of FIGS. 3 and 4). The Server NWDAF performs initial configuration (for ML architecture, initial model, initial training parameters, number of iteration rounds, terminate conditions, etc.) and controls the ML training process. In each iteration round, the Client NWDAFs perform local training based on their local data to generate local models and update the trained model information to the Server NWDAF. The Server NWDAF aggregates the received local models to generate global model, and then distributes the generated global model to the Client NWDAFs. The iteration for ML training repeated until the terminate conditions are satisfied.

During the multiple iteration rounds of training process, ML relevant models/parameters may be exchanged between the Server and Client NWDAFs. The corresponding services are needed for the ML relevant models/parameters exchanging in different phases of a ML training process, e.g., preparation requirements/parameters sending in the preparation phase, initial ML models/parameters distributing in the ML preparation phase, dynamic joining of new NWDAF in the ML execution phase, intermediate ML models/parameters exchanging in the ML execution phase, etc.

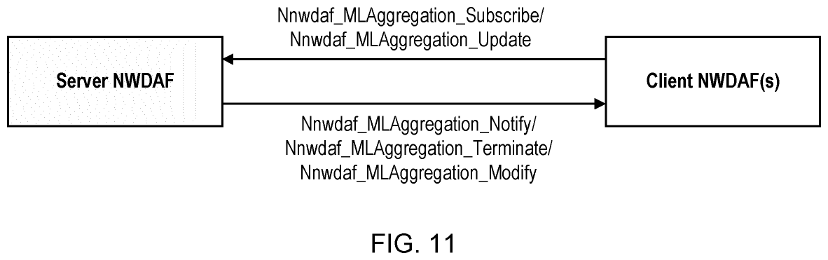

FIG. 11 shows the use of service operations of an Nnwdaf_MLAggregation service according to some embodiments, e.g., for trained parameters exchanging/models sharing in the ML training process. In the very beginning, i.e., the 0^{th} round, Server NWDAF distributes the initial model to the selected Client NWDAF(s).

In the 1^{st} round, the Client NWDAF(s) subscribe to the Server NWDAF for global model/parameter updating, e.g., by invoking an Nnwdaf_MLAggregation_Subscribe service operation together with the current round trained local models/parameters. Server NWDAF sends the aggregated global model/parameter to the Client NWDAF(s), e.g., by invoking an Nnwdaf_MLAggregation_Notify service operation.

In the i^{th} round, the Client NWDAF(s) update its subscription to the Server NWDAF for global model/parameter updating, e.g., by invoking an Nnwdaf_MLAggregation_Subscribe service operation to update the current subscription together with the subscription ID and current round trained local models/parameters. Server NWDAF sends the aggregated global model/parameter to the Client NWDAF(s), e.g., by invoking an Nnwdaf_MLAggregation_Notify service operation.

During the training process, the Server NWDAF may update the training status to the consumer if it is configured at the very beginning. The consumer may request to stop or update the current training due to, e.g., the requirement on accuracy can be satisfied by using the current trained model. Then, the Server NWDAF will terminate or update the current training process, e.g., by invoking an Nnwdaf_MLAggregation_Terminate or an Nnwdaf_MLAggregation_Modify service operation to terminate/update the training at the Client NWDAF(s). Or, if the training has been converged, the Server NWDAF terminates the training by invoking an Nnwdaf_MLAggregation_Terminate service operation. Or, if re-selection of Client NWDAF(s) is needed, the Server NWDAF modifies the training by invoking an Nnwdaf_MLAggregation_Modify service operation.

Alternatively, the trained models/parameters can be exchanged by using the extended Nnwdaf_MLProvision service.

More particularly, in some embodiments, a new service is proposed to support ML with multiple iteration rounds (e.g., FL, DML, etc.) among multiple NWDAF instances in 5GC. Table 1 shows the new service and service operations according to some embodiments.

TABLE 1
New services provided by NWDAF

| | Service | Operation | Example |
|---|---|---|---|
| Service Name | Operations | Semantics | Consumer(s) |
| Nnwdaf_MLAggregation | Subscribe | Subscribe/ | Client |
| | | Notify | NWDAF |
| | Unsubscribe | | Client |
| | | | NWDAF |
| | Notify | | Server |
| | | | NWDAF |
| | Update | | Client |
| | | | NWDAF |
| | Modify | Request/ | Server |
| | | Response | NWDAF |
| | Terminate | Request/ | Server |
| | | Response | NWDAF |

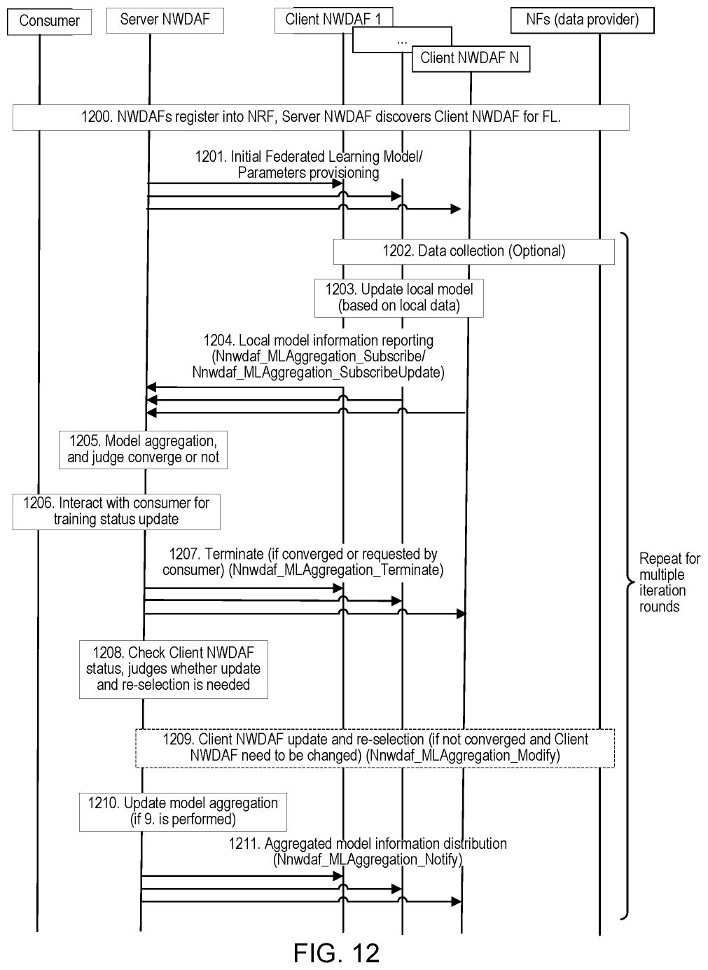

FIG. 12 illustrates a procedure for model sharing/parameter exchanging in ML execution phase according to some embodiments. The Nnwdaf_MLAggregation service is used in for model sharing/parameter exchanging in ML execution phase.

The procedure for model sharing/parameter exchanging in ML execution phase is as follows.

Step 1200: NWDAFs register into NRF with Federated Learning capability. Server NWDAF discovers Client NWDAFs based on e.g., Federated Learning capability, Analytics ID, etc. ML initial configuration, e.g., whether to update training status to consumer during the ML multiple iteration rounds of training, etc.

Step 1201: Server NWDAF starts initial FL parameters provisioning to all selected Client NWDAF with requirement on the ML process, e.g., time window for local model reporting, number of ML iteration rounds (e.g., M), etc., and the information of the initial global model, the FL correlation ID, the initial Iteration Round information (e.g., IR ID=0), endpoint Info, FL container, etc.

The FL container contains ML algorithm relevant parameters, e.g., ML algorithm, loss function, step weight, initial ML model weights, etc. (add reference . . . )

Step 1202: Client NWDAF(s) collect data from NFs (data provider).

Step 1203: Client NWDAF(s) update the initial model based on local data. Step 1203 comprises an example implementation of step 300 of FIG. 3

Step 1204: If the 1⁵t time for reporting local model information, Client NWDAF(s) send Nnwdaf_MLAggregation_Subscribe Request to the Service NWDAF. In the request may include the following information: (i) Local model information, e.g., local trained model/parameters (e.g., weights, gradients, etc.), timestamp, etc.; (ii) Identity of the current ML process, e.g., FL correlation ID; and/or (iii) Identity of the current iteration round, e.g., IR ID=1, 2, . . . , M. This report may be an example of a report in FIG. 1.

If not the 1^{st} time for reporting local model information, Client NWDAF(s) send Nnwdaf_MLAggregation_Subscribe Request to update the current subscription to the Service NWDAF. Alternatively, Client NWDAF can use an Nnwdaf_MLAggregation_Update service operation. In the request may include the following information: (i) Subscription ID; (ii) Local model information, e.g., local trained model/parameters (e.g., weights, gradients, etc.), timestamp, etc.; (iii) Identity of the current ML process, e.g., FL correlation ID; (iv) Identity of the current iteration round, e.g., IR ID=2, 3, . . . , M. This may also be an example of a report in FIG. 1. Step 1204, regardless of whether the 1^{st} time reporting local information or not, comprises an example implementation of step 310 of FIG. 3 or step 400 of FIG. 4.

Step 1205: Server NWDAF performs model aggregation on the received local models, and judges whether it is converged. Step 1205 comprises an example implementation of step 410 of FIG. 4.

Step 1206: If training status update is required in step 1200, Server NWDAF interacts with consumer for training status update. The consumer may request update or terminate the current ML training process according to the updated training status and its current requirement on accuracy, etc.

Step 1207: If converged as judged in step 1205 or requested by the consumer to terminate in step 1206, Server NWDAF sends request to Client NWDAF to terminate the current ML (e.g., FL) training process by invoking an Nnwdaf_MLAggregation_Terminate service operation with the parameters, e.g., FL correlation ID, etc. Step 1207 comprises an example implementation of step 440 of FIG. 4.

Step 1208: If not converged as judged in step 1205, Server NWDAF checks Client NWDAF status (Leave, Add, and Update, capacity, area, etc.), judges whether Client NWDAF re-selection is needed.

Step 1209: If not converged as judged in step 1205 and Client NWDAF re-selection is needed as judged in step 1208, or received request from the consumer to update the current ML process in step 1206, Server NWDAF starts the process for Client NWDAF re-selection or update the ML configuration based on the updated information in step 1208. Server NWDAF send update request to Client NWDAF(s) by invoking an Nnwdaf_MLAggregation_Modify service operation with FL container, updated ML parameters are contained in the FL container. Update the ML configuration, for example, change the time window for local model reporting, number of ML iteration rounds (i.e., change the value of M), ML algorithm, cost/loss function, optimizer (e.g., Gradient Descent algorithm, etc.), and the corresponding parameter setting (e.g., weights, learning rate, etc.), etc.

Step 1210: If update or re-selection is performed in step 1209, Server NWDAF updates the model aggregation and generates new global model.

Step 1211: Server NWDAF sends the aggregated model information to Client NWDAF(s) by invoking an Nnwdaf_MLAggregation_Notify service operation (may) with the following information: (i) Global model information, e.g., global aggregated model/parameters (e.g., weights, gradients, etc.), timestamp, etc.; (ii) Identity of the current ML process, e.g., FL correlation ID; and/or (iii) Identity of the current iteration round, e.g., IR ID=1, 2, 3, . . . , M. This message may be an example of the message 30 in FIG. 2.

The steps 1202-1211 may be repeated until the ML training terminate conditions are satisfied.

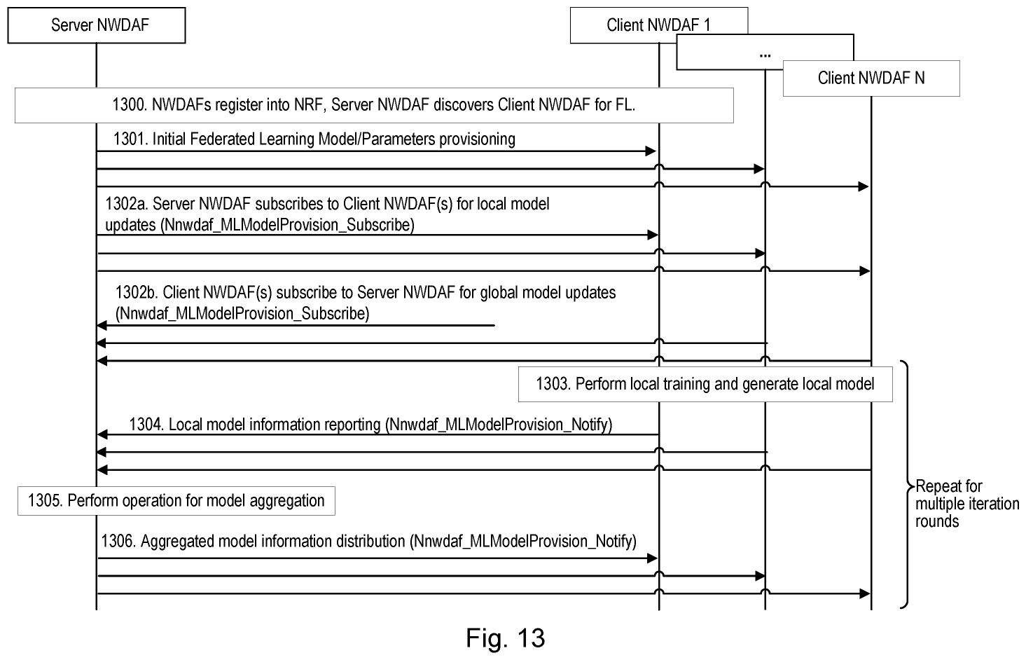

Alternatively, in other embodiments herein, the trained models/parameters may be exchanged by using an extended Nnwdaf_MLProvision service. FIG. 13 illustrates the procedure for model sharing/parameter exchanging in ML execution phase according to an example of such embodiments. The Nnwdaf_MLModelProvision service is used for model sharing/parameter exchanging in ML execution phase.

The corresponding procedure (as illustrated in FIG. 13) for model sharing/parameter exchanging in ML execution phase is as follows.

Step 1300: NWDAFs register into NRF with Federated Learning capability. Server NWDAF discovers Client NWDAFs based on e.g., Federated Learning capability, Analytics ID, etc. ML initial configuration, e.g., whether to update training status with the consumer during the ML multiple iteration rounds of training, etc.

Step 1301: Server NWDAF starts initial FL parameters provisioning to all selected Client NWDAF by invoking an Nnwdaf_MLModelProvision_Subscribe service operation with requirement on the ML process, e.g., time window for local model reporting, number of ML iteration rounds (e.g., M), etc., and the information of the initial global model, the FL correlation ID, the initial Iteration Round information (e.g., IR ID=0), etc.

Step 1302: Server NWDAF and Client NWDAF(s) subscribes to each other for local and global model updates. In Step 1302a, Server NWDAF subscribes to Client NWDAF(s) for local model updates by invoking an Nnwdaf_MLModelProvision service operation with FL correlation ID, etc. In Step 1302b, Client NWDAF(s) subscribes to Server NWDAF for global model updates by invoking an Nnwdaf_MLModelProvision service operation with FL Correlation ID, etc.

Step 1303: Client NWDAF(s) perform local training and generate local model.

Step 1304: Client NWDAF(s) send Nnwdaf_MLModelProvision_Notify to Service NWDAF, and may include the following information: (i) Local model information, e.g., local trained model/parameters (e.g., weights, gradients, etc.), timestamp, etc.; (ii) Identity of the current ML process, e.g., FL correlation ID; and/or (iii) Identity of the current iteration round, e.g., IR ID=1, 2, . . . , M. This report may be an example of a report in FIG. 1. Step 1304 comprises an example implementation of step 310 of FIG. 3 or step 400 of FIG. 4.

Step 1305: Server NWDAF performs operations for model aggregation on the received local models.

Step 1306: Server NWDAF sends the aggregated model information to Client NWDAF(s) by invoking an Nnwdaf_MLModelProvision_Notify service operation, and may include the following information: (i) Global model information, e.g., global aggregated model/parameters (e.g., weights, gradients, etc.), timestamp, etc.; (ii) Identity of the current ML process, e.g., FL correlation ID; and/or (iii) Identity of the current iteration round, e.g., IR ID=1, 2, 3, . . . , M. This message may be an example of the message 30 in FIG. 2.

The steps 1303-1306 may be repeated until the ML training terminate conditions are satisfied.

Embodiments herein also include corresponding apparatuses. Embodiments herein for instance include a client data analytics node configured to perform any of the steps of any of the embodiments described above for the client data analytics node.

Embodiments also include a client data analytics node comprising processing circuitry and power supply circuitry. The processing circuitry is configured to perform any of the steps of any of the embodiments described above for the client data analytics node. The power supply circuitry is configured to supply power to the client data analytics node.

Embodiments further include a client data analytics node comprising processing circuitry. The processing circuitry is configured to perform any of the steps of any of the embodiments described above for the client data analytics node. In some embodiments, the client data analytics node further comprises communication circuitry.

Embodiments further include a client data analytics node comprising processing circuitry and memory. The memory contains instructions executable by the processing circuitry whereby the client data analytics node is configured to perform any of the steps of any of the embodiments described above for the client data analytics node.

Embodiments herein also include a server data analytics node configured to perform any of the steps of any of the embodiments described above for the server data analytics node.

Embodiments also include a server data analytics node comprising processing circuitry and power supply circuitry. The processing circuitry is configured to perform any of the steps of any of the embodiments described above for the server data analytics node. The power supply circuitry is configured to supply power to the server data analytics node.

Embodiments further include a server data analytics node comprising processing circuitry. The processing circuitry is configured to perform any of the steps of any of the embodiments described above for the server data analytics node. In some embodiments, the server data analytics node further comprises communication circuitry.

Embodiments further include a server data analytics node comprising processing circuitry and memory. The memory contains instructions executable by the processing circuitry whereby the server data analytics node is configured to perform any of the steps of any of the embodiments described above for the server data analytics node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

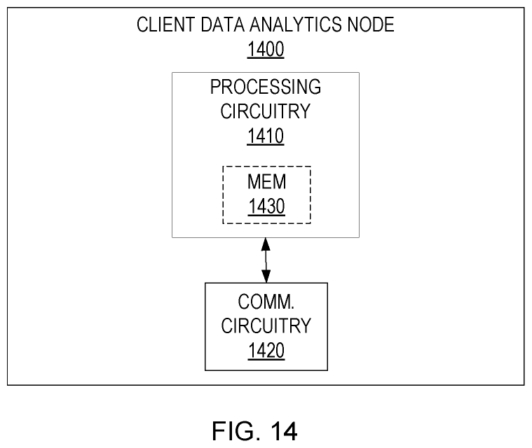

FIG. 14 for example illustrates a client data analytics node 1400 as implemented in accordance with one or more embodiments. As shown, the client data analytics node 1400 includes processing circuitry 1410 and communication circuitry 1420. The communication circuitry 1420 is configured to transmit and/or receive information to and/or from one or more other nodes, e.g., via any communication technology. The processing circuitry 1410 is configured to perform processing described above, e.g., in FIG. 3, such as by executing instructions stored in memory 1430. The processing circuitry 1410 in this regard may implement certain functional means, units, or modules.

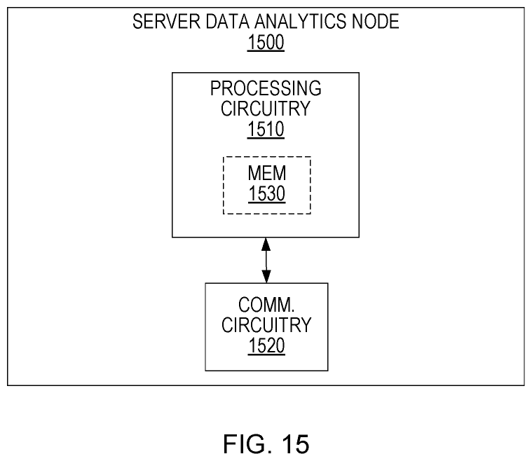

FIG. 15 illustrates a server data analytics node 1500 as implemented in accordance with one or more embodiments. As shown, the server data analytics node 1500 includes processing circuitry 1510 and communication circuitry 1520. The communication circuitry 1520 is configured to transmit and/or receive information to and/or from one or more other nodes, e.g., via any communication technology. The processing circuitry 1510 is configured to perform processing described above, e.g., in FIG. 4, such as by executing instructions stored in memory 1530. The processing circuitry 1510 in this regard may implement certain functional means, units, or modules.

Those skilled in the art will also appreciate that embodiments herein further include corresponding computer programs.

A computer program comprises instructions which, when executed on at least one processor of a data analytics node, cause the data analytics node to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of a data analytics node, cause the data analytics node to perform as described above.

Embodiments further include a computer program product comprising program code portions for performing the steps of any of the embodiments herein when the computer program product is executed by a data analytics node. This computer program product may be stored on a computer readable recording medium.

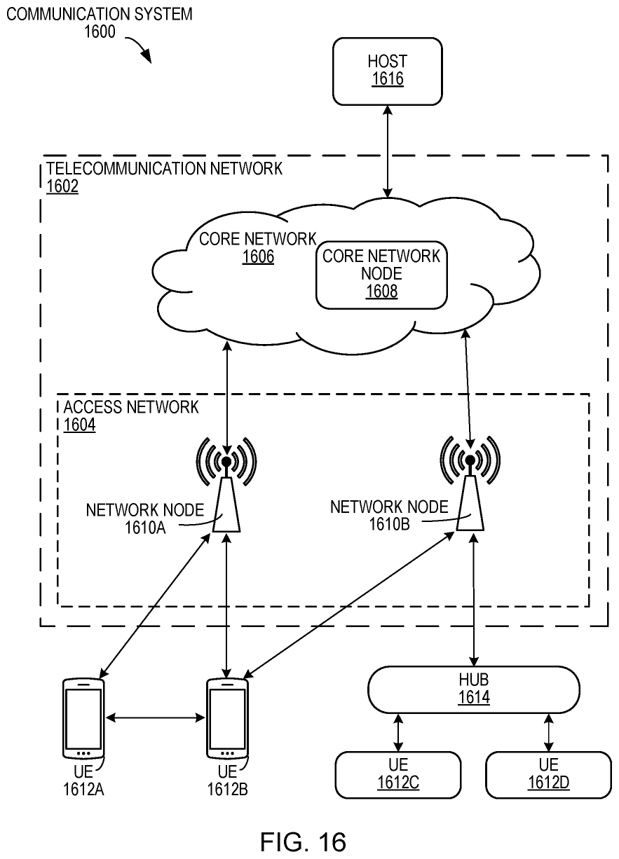

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3^{rd} Generation Partnership Project (3GPP) access node or non-3GPP access point. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular, if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

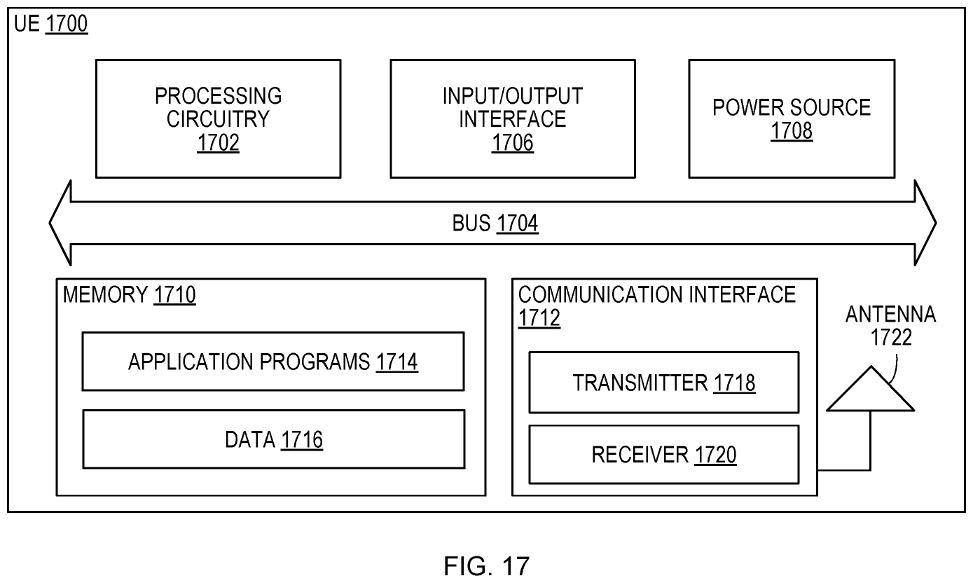

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

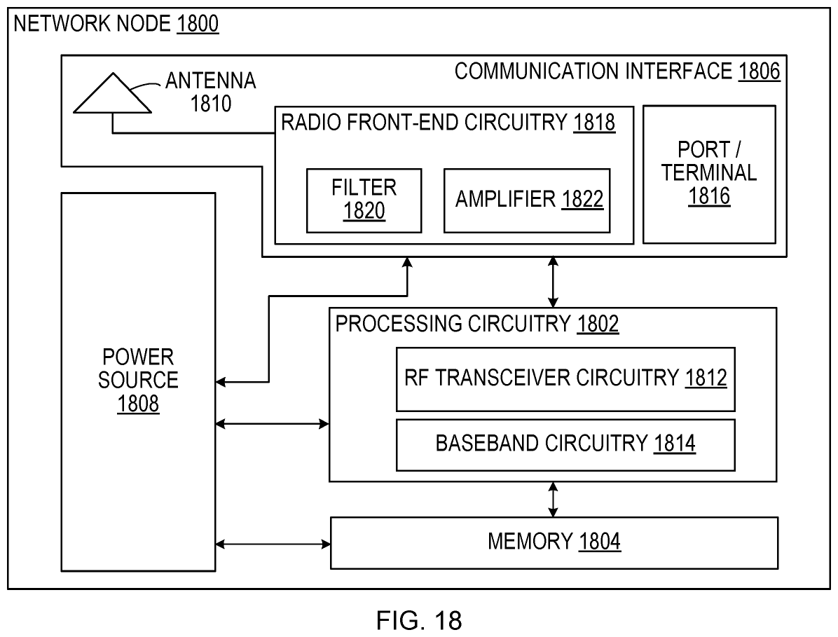

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

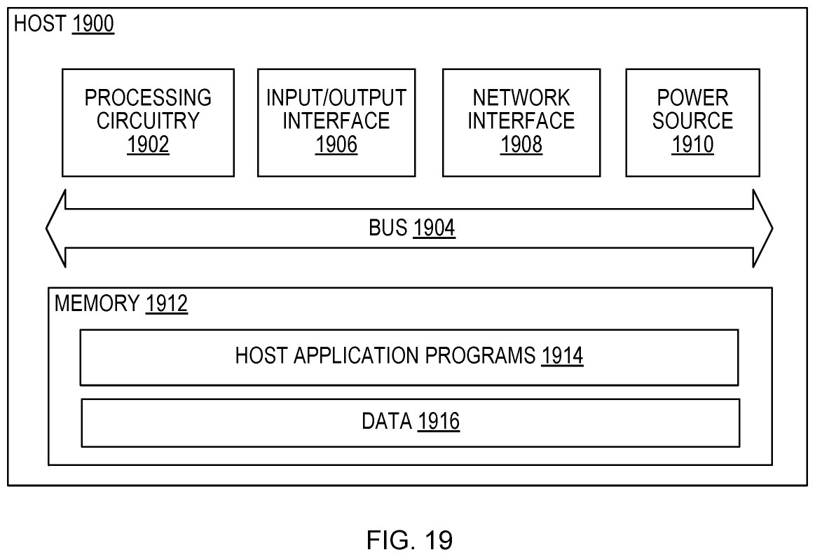

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

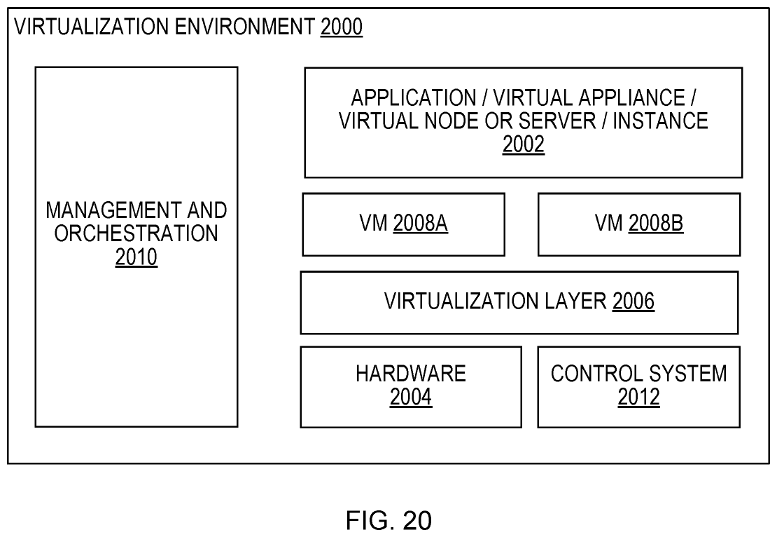

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

A1. A method performed by a client data analytics node configured for iterative machine learning training in a communication network, the method comprising, for each of multiple rounds of training:
training a local machine learning model at the client data analytics node with local training data;
transmitting, to a server data analytics node, a report that includes local model information resulting from the training in the round, wherein the report:
   identifies the round for which the report includes local model information; and/or
   identifies a version of global model information on which the local machine learning model trained in the round is based, wherein the version of the global model information either comprises initial global model information for an initial round of training or represents a combination of local model information reported to the server data analytics node for a previous round by multiple respective client data analytics nodes; and/or
   is transmitted according to a report timing requirement for the round.
      A2. The method of embodiment A1, wherein the report transmitted for each round identifies the round for which the report includes local model information.
      A3. The method of any of embodiments A1-A2, wherein, for each of one or more of the multiple rounds of training, the method further comprises:
obtaining the local machine learning model to be trained in the round, based on a version of global model information included in a message received from the server data analytics node in a previous round, wherein the message received from the server data analytics node in the previous round includes a round identifier that identifies the previous round, wherein training the local machine learning model comprises training the obtained local machine learning model;
obtaining a round identifier that identifies the round by incrementing the round identifier that identifies the previous round, wherein the report transmitted for the round includes the obtained round identifier that identifies the round;
receiving, from the server data analytics node, a message that includes:
the round identifier identifying the round; and
a version of global model information that represents a combination of local model information reported to the server data analytics node for the round by multiple respective client data analytics nodes.
   A4. The method of embodiment A3, wherein the report transmitted for the round further includes a version identifier that identifies the version of global model information on which the local machine learning model trained in the round is based.
   A6. The method of any of embodiments A1-A2, wherein, for each of one or more of the multiple rounds of training, the method further comprises:
before training the local machine learning model in the round, receiving, from the server data analytics node, a message that includes a round identifier identifying the round and that includes a version of global model information, wherein the version of the global model information represents a combination of local model information reported to the server data analytics node for a previous round by multiple respective client data analytics nodes; and
obtaining, based on the version of global model information included in the message, the local machine learning model to be trained in the round;
wherein training the local machine learning model comprises training the obtained local machine learning model; and
wherein the report transmitted for the round includes the round identifier included in the received message.
   A7. The method of embodiment A6, wherein the received message further includes a version identifier identifying the version of global model information, and wherein the report transmitted for the round further includes the version identifier included in the received message.
   A8. The method of any of embodiments A3-A7, further comprising transmitting, to the server data analytics node, a message that requests or updates a subscription to changes in global model information at the server data analytics node, wherein the message received from the server data analytics node is a message notifying the client data analytics node of a change in global model information at the server data analytics node in accordance with the subscription.
   A9. The method of any of embodiments A1-A8, wherein the report transmitted for each round is transmitted according to a report timing requirement for the round.
   A10. The method of embodiment A9, wherein the report timing requirement for the round requires that the report for the round be transmitted within a certain amount of time since a start of the round.
   A11. The method of any of embodiments A9-A10, further comprising receiving, from the server data analytics node, a message indicating the report timing requirement for each round.
   A12. The method of any of embodiments A1-A11, wherein the report transmitted for each round is included in a message that requests or updates a subscription to changes in global model information at the server data analytics node.
   A13. The method of any of embodiments A1-A11, further comprising receiving, from the server data analytics node, a message that requests or updates a subscription to changes in local model information at the client data analytics node, wherein the report transmitted for each round is included in a message that notifies the server data analytics node of changes in local model information at the client data analytics node.
   A14. The method of any of embodiments A1-A13, wherein the report transmitted for each round is transmitted during a machine learning execution phase as part of a machine learning aggregation service or a machine learning model provisioning service.
   A15. The method of any of embodiments A1-A14, further comprising receiving, from the server data analytics node, a message indicating a number of rounds of training to perform at the local data analytics node.
   A16. The method of any of embodiments A1-A15, further comprising refraining from training the local machine learning model over any further rounds of training responsive to receiving a message from the server data analytics node indicating that the client data analytics node is to terminate training.
   A17. The method of any of embodiments A1-A16, further comprising receiving, from the server data analytics node, a message indicating an endpoint to which to transmit the report for each round of training.
   A18. The method of any of embodiments A1-A17, further comprising receiving, from the server data analytics node, a message indicating an identifier of a machine learning process, wherein the report transmitted in each round includes the identifier of the machine learning process.
   A19. The method of any of embodiments A1-A18, further comprising receiving, from the server data analytics node, during one or more of the multiple rounds of training, a message that includes an updated machine learning configuration governing training of the local machine learning model.
   A20. The method of any of embodiments A1-A19, wherein:
local model information includes the local machine learning model or includes one or more parameters of the local machine learning model; and/or
global model information includes a global machine learning model at the server data analytics node or includes one or more parameters of the global machine learning model.
   A21. The method of any of embodiments A1-A20, wherein the local data analytics node implements a local Network Data Analytics Function, NWDAF, and wherein the server data analytics node implements a server NWDAF.
   A22. The method of any of embodiments A1-A21, wherein a start and/or end of each of the rounds of training is controlled by the server data analytics node.

### Group B Embodiments

B1. A method performed by a server data analytics node configured for iterative machine learning training in a communication network, the method comprising, for each of multiple rounds of training:
receiving, from each of multiple client data analytics nodes, a report that includes local model information resulting from training of a local machine learning model at the client data analytics node in the round, wherein the report:
   identifies the round for which the report includes local model information; and/or
   identifies a version of global model information on which the local machine learning model trained in the round is based, wherein the version of the global model information either comprises initial global model information for an initial round of training or represents a combination of local model information reported to the server data analytics node for a previous round by multiple respective client data analytics nodes; and/or
   is transmitted according to a report timing requirement for the round; and obtaining a version of global model information for the round by combining the local
   model information included in the received reports.
      B2. The method of embodiment 1, wherein each report received identifies the round for which the report includes local model information.
      B3. The method of any of embodiments B1-B2, wherein, for each of one or more of the multiple rounds of training, the method further comprises, transmitting, to each of the multiple client data analytics nodes, a message that includes a round identifier identifying the round and that includes the obtained version of global model information for the round.
      B4. The method of embodiment B3, wherein the message further includes a version identifier that identifies the obtained version of global model information for the round, and wherein each report received further includes a version identifier that identifies a previously obtained version of global model information for a previous round.
      B6. The method of any of embodiments B1-B2, wherein, for each of one or more of the multiple rounds of training except an initial round, the method further comprises, before receiving the reports, transmitting, to each of the multiple client data analytics nodes, a message that includes a round identifier identifying the round and that includes a version of global model information obtained for a previous round
      B7. The method of embodiment B6, wherein the message further includes a version identifier identifying the version of global model information included in the message, and wherein each report received for the round further includes the version identifier included in the transmitted message.
      B8. The method of any of embodiments B3-B7, further comprising receiving, from each of the multiple client data analytics nodes, a message that requests or updates a subscription to changes in global model information at the server data analytics node, wherein the message transmitted by the server data analytics node is a message notifying each client data analytics node of a change in global model information at the server data analytics node in accordance with the subscription.
      B9. The method of any of embodiments B1-B8, wherein each report received for each round is received according to a report timing requirement for the round.
      B10. The method of embodiment B9, wherein the report timing requirement for the round requires that the report for the round be received within a certain amount of time since a start of the round.
      B11. The method of any of embodiments B9-10, further comprising transmitting, to each of the client data analytics nodes, a message indicating the report timing requirement for each round.
      B12. The method of any of embodiments B1-B11, wherein each report received for each round is included in a message that requests or updates a subscription to changes in global model information at the server data analytics node.
      B13. The method of any of embodiments B1-B11, further comprising transmitting, to each of the client data analytics nodes, a message that requests or updates a subscription to changes in local model information at the client data analytics node, wherein each report received for each round is included in a message that notifies the server data analytics node of changes in local model information at the client data analytics node.
      B14. The method of any of embodiments B1-B13, wherein each report received for each round is received during a machine learning execution phase as part of a machine learning aggregation service or a machine learning model provisioning service.
      B15. The method of any of embodiments B1-B14, further comprising transmitting, to each of the client data analytics nodes, a message indicating a number of rounds of training to perform at the local data analytics node.
      B16. The method of any of embodiments B1-B15, further comprising stopping the client data analytics node from training respective local machine learning models at the client data analytics nodes over any further rounds of training by transmitting a message from the server data analytics node indicating that the client data analytics nodes are to terminate training.
      B17. The method of any of embodiments B1-B16, further comprising transmitting, to each of the client data analytics nodes, a message indicating an endpoint to which to transmit the report for each round of training.
      B18. The method of any of embodiments B1-B17, further comprising transmitting, to each of the client data analytics nodes, a message indicating an identifier of a machine learning process, wherein each report received in each round includes the identifier of the machine learning process.
      B19. The method of any of embodiments B1-B18, further comprising transmitting, to each of the client data analytics nodes, during one or more of the multiple rounds of training, a message that includes an updated machine learning configuration governing training of the local machine learning model at each client data analytics node.
      B20. The method of any of embodiments B1-B19, wherein:
local model information includes the local machine learning model at each respective client data analytics node or includes one or more parameters of the local machine learning model at each respective client data analytics node; and/or
global model information includes a global machine learning model at the server data analytics node or includes one or more parameters of the global machine learning model.
   B21. The method of any of embodiments B1-B20, wherein each local data analytics node implements a local Network Data Analytics Function, NWDAF, and wherein the server data analytics node implements a server NWDAF.
   B22. The method of any of embodiments B1-B21, wherein a start and/or end of each of the rounds of training is controlled by the server data analytics node.

### Group C Embodiments

C1. A client data analytics node configured to perform any of the steps of any of the Group A embodiments.
C2. A client data analytics node comprising processing circuitry configured to perform any of the steps of any of the Group A embodiments.
C3. A client data analytics node comprising:
communication circuitry; and
processing circuitry configured to perform any of the steps of any of the Group A embodiments.
   C4. A client data analytics node comprising:
processing circuitry configured to perform any of the steps of any of the Group A embodiments; and
power supply circuitry configured to supply power to the client data analytics node.
   C5. A client data analytics node comprising:
processing circuitry and memory, the memory containing instructions executable by the processing circuitry whereby the client data analytics node is configured to perform any of the steps of any of the Group A embodiments.
   C6. The client data analytics node of any of embodiments C1-C5, wherein the communication device implements a client Network Data Analytics Function, NWDAF.

### C7. Reserved.

C8. A computer program comprising instructions which, when executed by at least one processor of a client data analytics node, causes the client data analytics node to carry out the steps of any of the Group A embodiments.
C9. A carrier containing the computer program of embodiment C7, wherein the carrier is one of an electronic signal, optical signal, radio signal, or computer readable storage medium.
C10. A server data analytics node configured to perform any of the steps of any of the Group B embodiments.
C11. A server data analytics node comprising processing circuitry configured to perform any of the steps of any of the Group B embodiments.
C12. A server data analytics node comprising:
communication circuitry; and
processing circuitry configured to perform any of the steps of any of the Group B embodiments.
   C13. A server data analytics node comprising:
processing circuitry configured to perform any of the steps of any of the Group B embodiments;
power supply circuitry configured to supply power to the server data analytics node.
   C14. A server data analytics node comprising:
processing circuitry and memory, the memory containing instructions executable by the processing circuitry whereby the server data analytics node is configured to perform any of the steps of any of the Group B embodiments.
   C15. The server data analytics node of any of embodiments C10-C14, wherein the server data analytics node implements a server NWDAF.
   C16. A computer program comprising instructions which, when executed by at least one processor of a server data analytics node, causes the server data analytics node to carry out the steps of any of the Group B embodiments.
   C17. The computer program of embodiment C16, wherein the server data analytics node implements a server NWDAF.
   C18. A carrier containing the computer program of any of embodiments C16-C17, wherein the carrier is one of an electronic signal, optical signal, radio signal, or computer readable storage medium.

### REFERENCES

1. TR 23.700-80 (V0.3.0). “Study on 5G System Support for AI/ML-based Services”.
2. J. Liu, J. Huang, Y. Zhou, X. Li, S. Ji, H. Xiong, and D. Dou, “From distributed machine learning to federated learning: A survey.” arXiv preprint arXiv:2104.14362v4, Mar. 25, 2022.
3. S. Hu, X. Chen, W. Ni, E. Hossain, and X. Wang, “Distributed machine learning for wireless communication networks: Techniques, architectures, and applications.” IEEE Communications Surveys & Tutorials, vol. 23, No. 3, Third Quarter 2021.
4. Q. Li, Z. Wen, Z. Wu, S. Hu, N. Wang, Y. Li, X. Lu, and B. He, “A survey of federated learning system: Vision, hype and reality for data privacy and protection.” IEEE Transactions on Knowledge and Data Engineering, November 2021.
5. Q. Yang, Y. Liu, T. Chen, and Y. Tong, “Federated machine learning: Concept and applications.” arXiv preprint arXiv: 1902.04885v1, Feb. 13, 2019.
6. H. McMahan, E. Moore, D. Ramage, S. Hampson, and B. Arcas. “Communication-efficient learning of deep networks from decentralized data.” arXiv preprint arXiv:1602.05629v3, February 2017.
7. TR 23.700-81 (V0.3.0). “Study of Enablers for Network Automation for 5G, 5G System (5GS); Phase 3”.
8. TS 23.502 (V17.4.0). “Procedures for the 5G System (5GS); Stage 2”.
9. TS 23.288 (V17.4.0). “Architecture enhancements for 5G System (5GS) to support network data analytics services”.
10. TS 23.501 (V17.4.0). “System architecture for the 5G System (5GS); Stage 2”.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 5GC | 5G Core Network |
| DML | Distributed Machine Learning |
| FL | Federated Learning |
| IR | Iteration Round |
| ML | Machine Learning |
| NF | Network Function |
| NRF | Network Repository Function |
| NWDAF | Network Data Analytics Function |
| 1x RTT | CDMA2000 1x Radio Transmission Technology |
| 3GPP | 3rd Generation Partnership Project |
| 5G | 5th Generation |
| 6G | 6^{th} Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip divided by the |
| | power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MAC | Message Authentication Code |
| MBSFN | Multimedia Broadcast multicast service Single |
| | Frequency Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Power Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| USIM | Universal Subscriber Identity Module |
| UTDOA | Uplink Time Difference of Arrival |
| WCDMA | Wide CDMA |
| WLAN | Wide Local Area Network |

The invention claimed is:

1. A method performed by a client data analytics node for iterative machine learning training in a communication network, the method comprising, for each round of training:
training a local machine learning model at the client data analytics node with local training data; and
transmitting, to a server data analytics node, a report that includes local model information resulting from the training in the round, wherein the report comprises an identifier of the round for which the report includes local model information.

2. The method of claim 1, wherein the report identifies a version of global model information on which the local machine learning model trained in the round is based, wherein the version of the global model information either comprises initial global model information for an initial round of training or represents a combination of local model information reported to the server data analytics node for a previous round by multiple respective client data analytics nodes.

3. The method of claim 1, wherein the report is transmitted according to a report timing requirement for the round, and wherein the report timing requirement for the round requires that the report for the round be transmitted within a certain amount of time since a start of the round.

4. The method of claim 1, further comprising receiving, from the server data analytics node prior to the step of training, a message that includes the identifier of the round.

5. The method of claim 1, wherein, for each round of training, the method further comprises:
obtaining the local machine learning model to be trained in the round, based on a version of global model information included in a message received from the server data analytics node in a previous round, wherein the message received from the server data analytics node in the previous round includes a round identifier that identifies the previous round, wherein training the local machine learning model comprises training the obtained local machine learning model;
obtaining a round identifier that identifies the round by incrementing the round identifier that identifies the previous round, wherein the report transmitted for the round includes the obtained round identifier that identifies the round;
receiving, from the server data analytics node, a message that includes:
the round identifier identifying the round; and
a version of global model information that represents a combination of local model information reported to the server data analytics node for the round by multiple respective client data analytics nodes.

6. The method of claim 5, wherein the report transmitted for the round further includes a version identifier that identifies the version of global model information on which the local machine learning model trained in the round is based.

7. The method of claim 5, further comprising transmitting, to the server data analytics node, a message that requests or updates a subscription to changes in global model information at the server data analytics node, wherein the message received from the server data analytics node is a message notifying the client data analytics node of a change in global model information at the server data analytics node in accordance with the subscription.

8. (canceled)

9. The method of claim 3, further comprising receiving, from the server data analytics node, a message indicating the report timing requirement for each round.

10. The method of claim 1, wherein the report transmitted for each round is included in a message that requests or updates a subscription to changes in global model information at the server data analytics node.

11. The method of claim 1, further comprising at least one of:
receiving, from the server data analytics node, a message that requests or updates a subscription to changes in local model information at the client data analytics node, wherein the report transmitted for each round is included in a message that notifies the server data analytics node of changes in local model information at the client data analytics node;
receiving from the server data analytics node, a message indicating an endpoint to which to transmit the report for each round of training;
receiving, from the server data analytics nose, a message indicating an identifier of a machine learning process, wherein the report transmitted in each round includes the identifier of the machine learning process; and
receiving, from the server data analytics node, during one or more of the multiple rounds of training, a message that includes an updates machine learning configuration governing training of the local machine learning model.

12. The method of claim 1, wherein the report transmitted for each round is transmitted during a machine learning execution phase as part of a machine learning aggregation service of a machine learning model provisioning service.

13. (canceled)

14. (canceled)

15. (canceled)

16. The method of claim 1, wherein:
local model information includes the local machine learning model or includes one or more parameters of the local machine learning model; and/or
global model information includes a global machine learning model at the server data analytics node or includes one or more parameters of the global machine learning model.

17. The method of claim 1, wherein the local data analytics node implements a local Network Data Analytics Function (NWDAF) and wherein the server data analytics node implements a server NWDAF.

18. A method performed by a server data analytics node for iterative machine learning training in a communication network, the method comprising, for each round of training:
receiving, from each of multiple client data analytics nodes, a report that includes local model information resulting from training of a local machine learning model at the client data analytics node in the round, wherein the report comprises an identifier of the round for which the report includes local model information; and
updating a global model information for the round based on the local model information included in the received reports.

19. The method of claim 18, wherein the report identifies a version of global model information on which the local machine learning model trained in the round is based, wherein the version of the global model information either comprises initial global model information for an initial round of training or represents a combination of local model information reported to the server data analytics node for a previous round by multiple respective client data analytics nodes.

20. The method of claim 18, wherein the report is received according to a report timing requirement for the round, and wherein the report timing requirement for the round requires that the report for the round be received within a certain amount of time since a start of the round.

21. The method of claim 18, further comprising transmitting, to the multiple client data analytics nodes prior to the receiving step, a message that includes the identifier of the round.

22. The method of claim 18, wherein the step of updating comprises aggregating the local model information included in the received reports.

23. The method of 18, wherein, for each of the multiple rounds of training except an initial round, the method further comprises, before receiving the reports, transmitting, to each of the multiple client data analytics nodes, a message that includes a round identifier identifying the round and that includes a version of global model information obtained for a previous round.

24. The method of claim 18, further comprising receiving, from each of the multiple client data analytics nodes, a message that requests or updates a subscription to changes in global model information at the server data analytics node, wherein the message transmitted by the server data analytics node is a message notifying each client data analytics node of a change in global model information at the server data analytics node in accordance with the subscription.

25. (canceled)

26. The method of claim 20, further comprising transmitting, to each of the client data analytics nodes, a message indicating the report timing requirement for each round.

27. The method of claim 18, wherein each report received for each round is included in a message that requests or updates a subscription to changes in global model information at the server data analytics node.

28. The method of claim 18, further comprising at least one of:
transmitting, to each of the client data analytics nodes, a message that requests or updates a subscription to changes in local model information at the client data analytics node, wherein each report received for each round is included in a message that notifies the server data analytics node of changes in local model information at the client data analytics node;
transmitting, to each of the client data analytics nodes, a message indicating an endpoint to which to transmit the report for each round of training;
transmitting, to each other of the client data analytics nodes, a message indicating an identifier of a machine learning process, wherein each report received in each round the identifier of the machine learning process; and
transmitting, to each of the client data analysis nodes, during one or more of the multiple rounds of training, a message that includes an updates machine learning configuration governing training of the local machine learning model at each client data analytics node.

29. The method of claim 18, wherein each report received for each round is received during a machine learning execution phase as part of a machine learning aggregation service or a machine learning model provisioning service.

30. (canceled)

31. (canceled)

32. (canceled)

33. The method of claim 18, wherein:
local model information includes the local machine learning model at each respective client data analytics node or includes one or more parameters of the local machine learning model at each respective client data analytics node; and/or
global model information includes a global machine learning model at the server data analytics node or includes one or more parameters of the global machine learning model.

34. The method of claim 18, wherein each local data analytics node implements a local Network Data Analytics Function (NWDAF) and wherein the server data analytics node implements a server NWDAF.

35. (canceled)

36. A client data analytics node comprising:
processing circuitry and memory, the memory containing instructions executable by the processing circuitry whereby the client data analytics node is configured to:
train a local machine learning model at the client data analytics node with local training data, and
transmit, to a server data analytics node, a report that includes local model information resulting from the training in the round, wherein the report comprises an identifier of the round for which the report includes local model information.

37. (canceled)

38. (canceled)

39. A server data analytics node comprising:
processing circuitry and memory, the memory containing instructions executable by the processing circuitry whereby the server data analytics node is configured to:
receive, from each of the multiple client data analytics nodes, a report that includes local model information resulting from training of a local machine learning model at the client data analytics node in the round, wherein the report comprises an identifier of the round for which the report includes local model information; and
update a global model information for the round based on the local model information included in the received reports.

40. (canceled)
